(19) United States
(12) Patent Application Publication
(10) Pub. No.: US 2007/0209301 A1
(43) Pub. Date: Sep. 13, 2007

(54) Earthquake damage resistant glass panel

(76) Inventors: Ali M. Memari, State College, PA (US); Paul A. Kremer, State College, PA (US); Richard A. Behr, State College, PA (US)

Correspondence Address: MCDERMOTT WILL & EMERY LLP, 600 13TH STREET, N.W., WASHINGTON, DC, 20005-3096, US

(21) Appl. No.: 11/716,024

(22) Filed: Mar. 9, 2007

Related U.S. Application Data
(63) Continuation-in-part of application No. 10/233,670, filed on Sep. 4, 2002.

(51) Int. Cl. E06B 3/54

(52) U.S. Cl. 52/204.5; 52/741.1

(57) ABSTRACT

Architectural glass panels for use in a wide variety of building wall systems, such as curtain walls and storefronts, which have improved resistance to damage from earthquake and/or other loads that could cause horizontal racking movements of architectural glass panels within their glazing frames are disclosed. Embodiments include various types of architectural glass panels that have material removed at panel corners and are fabricated with smooth edge contours in the corner regions. A preferred embodiment includes various types of architectural glass panels that have rounded corners with edges finished as deemed appropriate for the glass panel type.

### RELATED APPLICATION DATA AND GOVERNMENT RIGHTS

The present application is a continuation-in-part of U.S. application Ser. No. 10/233,670 filed Sep. 4, 2002. The subject matter of this application was made with support of the National Science Foundation under Grant No. 9983896. The Government may have certain rights in the invention.

### FIELD OF THE INVENTION

The present invention relates to architectural glass panels suitable for use in a wide variety of architectural glass and building wall system framing combinations. In particular, the present invention relates to architectural glass panels having a modified geometry and edge finish to improve their resistance to damage during earthquakes and/or other movement of the glass panels within their frames.

### BACKGROUND

In light of recent earthquakes in the United States, Japan and elsewhere, considerable attention is now directed toward developing buildings that resist damage during earthquakes. Although the seismic performance of load bearing structures in buildings has improved, “non-structural” or architectural building elements have proved to be vulnerable to earthquake-induced damage. For example, curtain walls (a curtain wall is any exterior building wall comprised of any material, which carries no superimposed vertical loads and is “hung” on the building structural frame) and storefront wall systems have shown the vulnerability of architectural glass and related glazing components to damage during earthquakes. This damage includes serviceability failures (e.g., glazing gasket dislodging, sealant damage, glass edge damage and glass cracking), which require expensive building repairs and could ultimately lead to failures in the form of glass fallout, which present a life safety hazard. Earthquake-induced architectural glass glazing system failures lead to costly repairs and can impose liabilities to building designers, building contractors, building owners and insurers.

In response to concerns about nonstructural damage during earthquakes, recent model building codes, e.g., International Building Code (IBC), 2006(ICC 2006), now require consideration of seismic design provisions in American Society of Civil Engineers (ASCE) 7-05 Minimum Design Loads for Buildings and Other Structures (ASCE 2006). According to ASCE 7-05, nonstructural components, such as architectural glass panels, shall accommodate the maximum allowed building story drifts. More specifically, exterior nonstructural wall panels or elements that are attached to or enclose the structure shall be designed to resist the forces prescribed by an equation presented in the model building code and shall accommodate movements of the structure resulting from response to design basis ground motions. In general, seismic codes require wall systems to accommodate drift without much guidance on how to achieve “acceptable” seismic performance for various wall system types. The new seismic design provisions for architectural glass are based on a combination of design experience and laboratory test data. Moreover, these provisions reference AAMA (American Architectural Manufacturers Association) test procedures (AAMA 2001) for determining the serviceability and glass fallout resistance of curtain wall and storefront wall system mock-ups. Although the AAMA standard test procedures do not cover wall system types other than curtain walls and storefronts, these two wall system types are prevalent in modern building practice.

Aside from those glass configurations specifically exempted from mock-up testing in the ASCE 7-05 design provisions, selection of appropriate architectural glazing configurations for seismic resistance can be a challenging and iterative process. Fortunately, a series of laboratory studies and some post-earthquake reconnaissance surveys conducted during the last twenty years have generated a significant database on the expected seismic performance of various combinations of architectural glass and wall system framing types (Memari et al. 2006a, Memari et al. 2006b, Memari et al. 2004, Memari et al. 2003, Memari et al. 2002a, EERI 2001, Behr 1998, Behr and Belarbi 1996, Behr et al. 1995a, Behr et al. 1995b, EERI 1995, Pantelides and Behr 1994, Lingnell 1994, Culp and Behr 1993, Wang 1992, King and Thurston 1992, Thurston 1992, Deschenes et al. 1991, Lim and King 1991, EEI 1990, Wright 1989, Evans et al. 1988, Sakamoto et al. 1984, Sakamoto 1978). Additional studies have been directed toward the development of seismic isolation methods for new wall system installations and techniques to predict and mitigate glass damage and glass fallout in existing wall systems (Memari et al. 2007, Memari et al. 2006b, Memari et al. 2006c, Memari et al. 2002b, Memari and Kremer 2001, Brueggeman et al. 2000, Memari et al. 2000, Zharghamee 1996).

Several methods are available to mitigate architectural glass damage caused by earthquakes, but there is an ongoing need to improve both the glass cracking resistance and the glass fallout resistance in earthquake prone regions and elsewhere.

One method of improving the earthquake resistance of architectural glass is to use laminated glass, which usually consists of two glass plies bonded together with a transparent polymeric interlayer such as polyvinyl butyral (PVB). Specialty laminated glass configurations are also available as glass-plastic laminates and laminates with multiple layers of glass and/or plastic. Laminated glass, particularly when the glass plies are made of either annealed glass or heat-strengthened glass, is highly resistant to glass fallout because any broken glass fragments remain adhered to the PVB interlayer and resist falling dangerously from the wall system glazed opening. However, individual glass plies in a laminated glass unit are still vulnerable to cracking at drift levels comparable to monolithic glass panels with square-edged corners of the same nominal thickness as the laminated glass unit. Furthermore, a cracked laminated glass unit would still need to be replaced at a significant cost. Hence, the use of laminated glass can improve resistance to glass fallout, but not the resistance to glass cracking.

Another earthquake-resistant glazing method is to apply a polymeric film such as polyethylene terephthalate (PET) over the entire glass surface and to use an appropriate anchoring technique to secure the film edges to the wall system framing. This method, like the use of laminated glass, can resist glass fallout effectively, but does not necessarily resist glass cracking. Although anchored films are used widely to retrofit in-service glass panels, application of anchored films is labor intensive, and anchored film installations often require a high degree of workmanship in the film application and the film anchorage installation that is a challenge to achieve properly in the field. Unanchored films, sometimes applied as a seismic retrofit measure, are not completely effective in preventing glass fallout due to earthquake-induced building motions (Behr 1998).

For some wall system designs it is possible to use deeper glazing pockets for frame members that hold the glass, thereby providing larger glass-to-frame clearances in an attempt to avoid glass-to-frame contact during racking displacements in an earthquake. This method presumes that the glass panel will have more freedom to translate and rotate within the glazing pocket, thus avoiding early glass failure under racking conditions. This solution, however, is costly in terms of the amount of wall system materials utilized, and is not always preferred architecturally because it requires the use of wide mullions to provide the required glass-to-frame clearances needed to avoid glass-to-frame contact. Moreover, if the glass panel is shifted too far laterally in a particular direction due to in-service conditions or faulty installation, the weatherseal of the framing system can be compromised and the glass itself could be more vulnerable to cracking under subsequent wall system racking movements.

Finally, seismically isolated wall systems using unitized framing, or the recently developed “Earthquake Isolated Curtain Wall System” (EICWS) are also available. Typically, isolated wall systems are designed to accommodate in-plane racking movements, but the EICWS can accommodate movements in any direction because it permits the multidirectional sliding of the curtain wall in one story relative to adjacent stories. Although the EICWS solution is capable of providing a high level of earthquake resistance to virtually any type of architectural glass and any type of glazing system, the EICWS is designed primarily for new building construction, and, like other seismically isolated wall systems, could impose additional building design and construction costs.

Although glass with anchored safety films, laminated glass, larger glass-to-frame clearances (i.e., wide mullion designs) and seismically isolated wall systems can be used to mitigate earthquake-induced building envelope damage, these methods have disadvantages. Specifically, due to cost and complexity, most earthquake-resistant wall systems are tailored primarily for new building construction, not building retrofits; most earthquake-resistant wall systems are significantly more expensive than conventional wall systems not designed specifically for earthquake resistance; most earthquake-resistant wall systems increase glass fallout resistance, but not all of these systems increase glass cracking resistance; and some earthquake-resistant wall systems limit aesthetic choices in the architectural design of a building's exterior. As a result, there is an ongoing need to improve both the glass cracking resistance and the glass fallout resistance of architectural glass under earthquake loading conditions or conditions that cause such damage.

### BRIEF SUMMARY OF THE INVENTION

An advantage of the present invention is an earthquake damage resistant architectural glass panel for buildings.

Another advantage of the present invention is a method of increasing glass cracking resistance, and for most glass configurations, the glass fallout resistance of glass panels used in various building wall framing systems.

Additional advantages and other features of the invention will be set forth in part in the description, which follows, and in part will become apparent to those having ordinary skill in the art upon examination of the following or may be learned from the practice of the invention. The advantages of the invention may be realized and obtained as particularly presented in the appended claims.

According to the present invention, the foregoing and other advantages are achieved in part by a building comprising at least one rectangular window frame having an architectural glass panel with rounded corners and finished edges therein.

Embodiments of the present invention include architectural glass panels that have material removed at panel corners and are fabricated with smooth edge contours in the modified-geometry corner regions. Preferred embodiments of the present invention include glass panels that have their corners rounded, i.e., formed by curving the area where at least two edges or sides of the glass intersect, and by finishing their edges as by polishing. Preferably the modified-geometry corner regions and all or part of the remaining edges of the glass are polished to a mirror-like finish, i.e., a finish that appears mirror-like to the naked eye, and without visible imperfections (e.g., protrusions, pits, scratches, chips, cracks, and deviations from the defined radius of curvature) to the naked eye. In certain embodiments, the architectural glass panel of the present invention has improved serviceability and ultimate drift capacity over the same glass having a square corner geometry of at least about 20%, 30%, 40%, 50% or more. Buildings that employ such modified-geometry glass components within a rectangular frame advantageously resist damage to their glass panels and related damage from broken and falling glass fragments caused by earthquake-induced frame and glass movements. The damage resistant architectural glass panels of the present invention can be employed with various framing materials used in wall system construction, such as glass, stone, aluminum, steel, additional metals or alloys, plastics, rubber, wood, sealants/adhesives and composites of the above.

Another aspect of the present invention is a method of increasing the earthquake damage resistance of the original glass panels in a building. The method comprises replacing or retrofitting the original glass panels in the building with glass panels having rounded corners.

Additional advantages of the present invention will become readily apparent to those having ordinary skill in the art from the following detailed description, wherein the embodiments of the invention are described simply by way of illustrating the best modes contemplated for carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIGS. 1(a), 1(b), 1(c), and 1(d) illustrate schematic representations of the first three natural in-plane vibration modes of a typical building frame clad with a conventional curtain wall system, and their effects on the structural frame and curtain wall of the building.

FIGS. 2(a), 2(b), and 2(c) illustrate schematic representations of typical in-plane forces acting on an individual curtain wall element during an earthquake. Glass movements and loads are contrasted for a conventional architectural glass panel with rectangular corners and a rounded corner architectural glass panel.

FIG. 3 is a front view of a rounded corner monolithic glass panel as fabricated in accordance with an embodiment of the present invention.

FIG. 4 is an isometric view of a rounded corner monolithic glass panel with radius of curvature R.

FIG. 5 is an isometric view of a rounded corner monolithic glass panel with flat polished edges.

FIGS. 6(a) and 6(b) show a rounded corner glass panel, fabricated in accordance with the invention, that include a shaped edge (e.g., either a flat FIG. 6(a) or a pencil FIG. 6(b) edge).

FIG. 7(a) is an elevation view of one corner of a monolithic glass panel constructed with asymmetrically rounded corners; and FIG. 7(b) is an elevation view of one corner of a monolithic glass panel constructed in accordance with the invention by removing material and smoothing the edge surfaces from the corners of the panel.

FIG. 8 is an isometric view of one corner of an insulating glass unit comprised of glass panes with rounded corners.

FIG. 9 is an isometric view of one corner of a laminated glass unit comprised of glass plies with rounded corners.

FIG. 10 is an isometric view of one corner of a filmed glass panel employing rounded corners.

FIG. 11 is an elevation view and corresponding cross-sectional view of the glazing details for an anchored film glass installation in a dry-glazed, curtain wall frame used in mid-rise building construction.

FIG. 12 is a graph illustrating the effect of glass type on drift capacities for conventional square-corner monolithic glass panels and flat-polished monolithic glass panels.

FIG. 13 is a graph of the effect of corner radius on seismic drift capacities for annealed monolithic glass panels with cut edges and ground corners.

FIG. 14 is a graph comparing the seismic drift capacities for annealed, heat-strengthened and fully tempered monolithic rounded corner glass panels with various edge/corner finishes with the drift capacities of identically constructed glass panels with rectangular corners and conventionally finished edges.

FIG. 15 depicts the drift time history employed for AAMA 501.6 dynamic racking crescendo tests.

FIG. 16(a) is an isometric view of a flat-polished corner on a monolithic glass plate; FIG. 16(b) is an edge view of a flat-polished edge with a mirror finish; and FIG. 16(c) illustrates a rough edge finish.

FIG. 17 depicts the corner edge finish for Configurations 2-5 in Table 1 and FIG. 13.

FIG. 18 shows the typical damage origin for annealed monolithic glass plates with rounded corners employing the edge finish shown in FIG. 17.

FIG. 19 illustrates the edge finish for an embodiment of the present invention.

FIG. 20 is a graph showing the drift capacities of annealed, heat-strengthened, and fully tempered monolithic glass panels and annealed and heat-strengthened insulating glass panels employing the edge finish shown in FIG. 19.

### DETAILED DESCRIPTION OF THE INVENTION

The present invention is directed to a novel architectural glass panel with modified-geometry corners and proven edge finishes within a wall system for providing earthquake damage resistance to the glass panel. The invention is applicable to a variety of glass types (e.g., monolithic glass, laminated glass units, or insulating glass units) and in a variety of wall system types (e.g., curtain walls and storefronts).

As used herein, architectural glass is characterized as a sheet-like pane of glass where the thickness dimension is considerably less than the width and the height dimensions of the glass. The dimensional tolerances for flat glass, which is produced by the float glass process, from which the majority of architectural glass panel units (monolithic, laminated and insulating glass) are fabricated, range in thickness from about ⅛ in. to about 1-2 in. See, e.g., ASTM C1036-01. Architectural glass does not include glass blocks which are considered a masonry product.

Laboratory investigations performed by the inventors have revealed that modifying the corner geometry of conventional, square-corner architectural glass panels, for example, by rounding the corners of the glass panels and by finishing the glass panel edges, economically increases the glass cracking resistance and, to a lesser degree, the glass fallout resistance of virtually any glass component within conventional wall systems. Research has also indicated that glass damage under dynamic racking conditions is initiated at the corners of rectangular glass panels. Glass panels having modified corner geometries (e.g., rounded corners) experience reduced friction between the glass corners and the glazing pocket during glass-to-frame contacts, and have slightly reduced glass plate diagonal lengths, which allows them to slide more freely at the corners during the glass-to-frame contacts that can occur when the frame is subjected to dynamic, horizontal racking movements as would be expected during an earthquake. The increased mobility of the modified-geometry glass panel within its glazing pocket allows the glass panel to adjust more readily to increased frame deformation, and can increase both the serviceability (glass cracking) and ultimate (glass fallout) drift capacities of architectural glass panels. Drift capacities are measures related to the seismic performance of architectural glass. The serviceability drift capacity, Δ_{cracking}, is defined as the horizontal racking displacement that causes observable glass cracking in the glass panel, a condition that would necessitate glass replacement, but one that would not pose an immediate life safety hazard (Behr, 1998). The ultimate drift capacity, Δ_{fallout}, is defined as the horizontal racking displacement that causes a glass fragment larger than about 645 mm2 (1 in. ²) to fall from the glass panel, a condition that could pose a life-safety hazard to building occupants or pedestrians (Behr, 1998). Laboratory equipment and detailed procedures for determining Δ_{cracking} and Δ_{fallout} drift capacities are described by Brueggeman et al. (2000). Improvements in glass performance (i.e., increased drift capacities) can be attained more economically with modified geometry (e.g., rounded) corner glass panels than with other seismic mitigation methods. The seismic resistance benefit of glass components fabricated with modified corner geometries and with finished edges is provided at only modest cost increments relative to conventional glass components.

The architectural glass panels, made according to the present invention and used in commercial and residential building wall systems, advantageously have an increased ability to accommodate, without glass damage, earthquake-induced building motions as compared to conventional architectural glass panels with square corners.

Architectural glass panels of the present invention can be used as components in simple structural walls or more elaborate wall systems that are designed to provide seismic resistance. Some seismic isolation designs achieve isolation through a special connection of the wall system frame to the building structural frame. It is believed that seismically isolated walls would benefit by using glass panels of the present invention. The glass panels of the present invention may also be used with wide mullions (vertical member in various wall framing systems) with large glass-to-frame clearances (i.e., deep glazing pockets), and to improve incrementally the seismic resistance of architectural glass components installed in a variety of specially constructed wall framing systems designed to accommodate in-plane racking displacements (Zarghamee 1996 and Ting 2001).

Glass panels of the present invention can be used advantageously in both new building construction and building retrofit situations, and within various framing types including, but not limited to, curtain wall and storefront framing with or without seismic isolation connections, and window framing used as infill in exterior building envelope wall systems. When properly fabricated and glazed, glass panels of the present invention can achieve seismic resistance at a lower cost and with less construction complexity than existing seismic isolation methods.

In practicing certain embodiments of the present invention, previously square or other angular (e.g., obtuse or acute angle) glass corners are curved and finished during the fabrication of the glass. It has been discovered that modifying the geometry (e.g., rounding the corners) of a conventional glass panel provides the glass panel with the freedom to reposition itself within the glazing pocket of the conventional wall system frame during earthquake-induced wall frame racking deformations, thereby increasing the in-plane lateral displacement capacity of the wall system as compared to conventional rectangular glass panels with square or otherwise angular corners. It has also been discovered that by polishing all edges and corners of the glass panel, or at a minimum the corner regions of the glass panel to a smooth, mirror-like finish (with no discernable (to the naked eye) imperfections in the finish due to protrusions, pits, scratches, chips, cracks, and deviations from the defined radius of curvature), the earthquake damage resistance of the glass as measured by drift capacities is further improved. An example is a glass panel having a flat polish with a consistent mirror polish luster with no finish discontinuities applied in each corner region such that the polish extends beyond the tangent points of each rounded corner and wherein the glass panel has seamed or finely ground edges along all other portions of the glass panel edges.

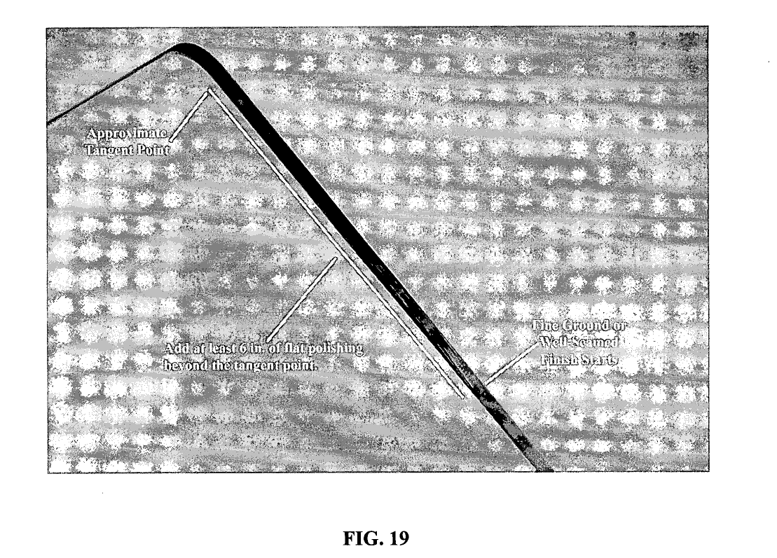

Preferably, the side edges of the glass are also polished to a smooth, mirror finish at least 6 inches or more from the tangent points of each rounded corner of the glass panel. See, e.g., FIG. 19. As a result, glass panels of the present invention are able to sustain additional inter-story drift before any sign of glass cracking or glass fallout. The term “rounded corner” as used herein includes corners formed by removing glass from the conventional square or angular corner of a glass panel, such as by curving the square or angular corner using a single radius, double or asymmetric radii, or multiple radii. Additionally, the term includes any flat or curved segment formed by the removal of glass from the square or angular corner portion of the conventional glass panel and smoothing the resulting edge surface profile.

The mechanics by which architectural glass panels achieve improved damage resistance during an earthquake in certain embodiments relates to the removal of glass-to-frame contact stress concentration points at the angular corners, which typically occur in conventional, square-corner glass panels undergoing dynamic racking displacements within a wall system frame.

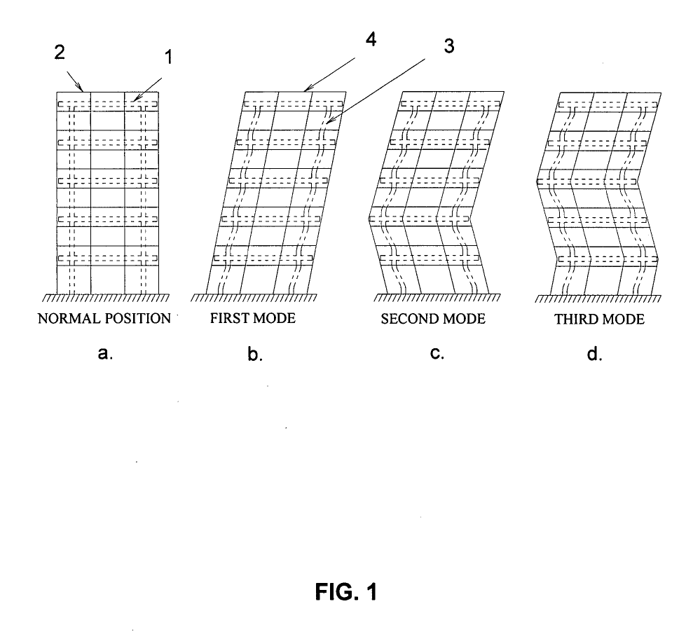

For example, as depicted schematically in FIGS. 1(a) to 1(d), under in-plane lateral displacements of buildings during earthquakes, the main structural frame 1 of the building will distort 3. The schematic depictions of the first three natural vibration modes of a typical building frame clad with a conventional curtain wall system 2 shown in FIG. 1 have been limited to in-plane lateral interstory drifts because these are, in general, the most damaging movements to building wall systems. These interstory movements in the building's main structural frame 1, as shown in FIGS. 1(b), 1(c), and 1(d), typically distort the structural frame 3, causing the normally rectangular curtain wall frame to distort into parallelograms 4, which can lead to subsequent wall system panel (e.g., architectural glass panels, stone and concrete panels, etc.) damage.

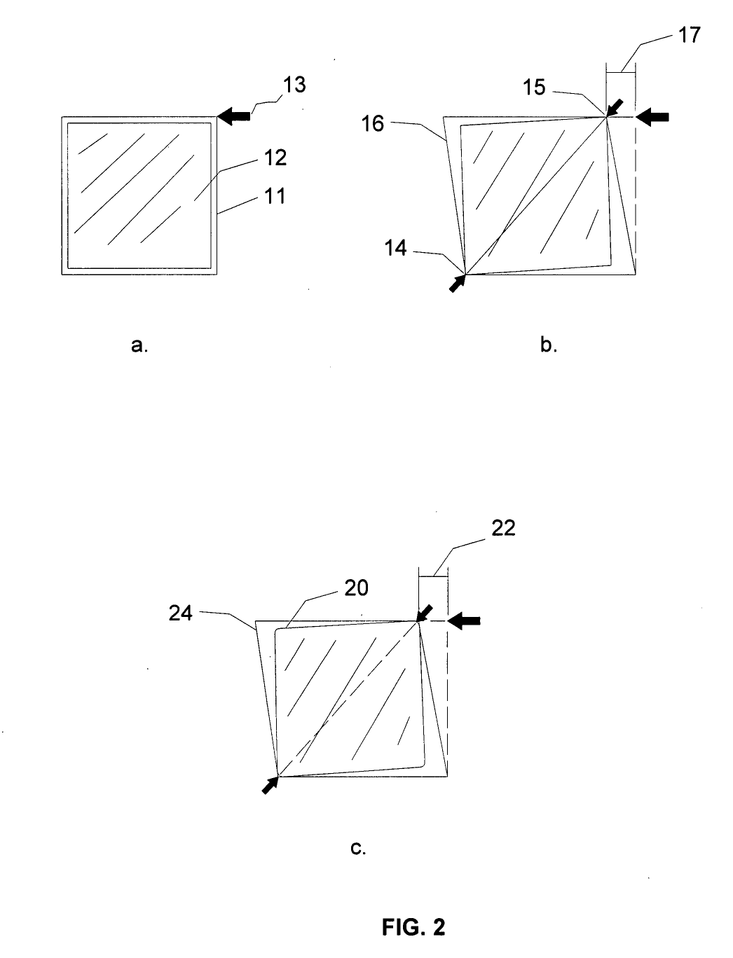

Most earthquake-induced damage to architectural glass panels stems from the distortion of the glazing frame that holds the glass component as depicted in FIG. 1 and isolated to an individual frame 11 and glass panel 12 element in the schematic depiction of FIG. 2. As noted by Bouwkamp 1960 and Sucuoglu and Vallabhan 1997, in-plane deformation of the frame 11 in FIG. 2a holding the architectural glass panel under horizontal racking motion (shear force shown) 13 causes the glass panel to translate and rotate within the glazing frame. As shown in FIG. 2b, when the corners of one diagonal of the glass plate 14 and 15 make contact with the corners corresponding to the shorter diagonal of the distorted curtain wall frame 16 (in the shape of a parallelogram having inter-story drift 17), additional inter-story drift causes glass to crush and fracture under the in-plane compressive contact forces generated between the glass corners and the corners of the wall system frame. For design purposes, it is preferred that the interaction of brittle glass plates and glazing frame pockets during inter-story drift be accommodated by accepted, verified, seismic design features. The glass panels of the present invention are now one such verified seismic design feature. As shown in FIG. 2c, the modified-geometry corners (e.g., rounded corners) shorten the diagonal length of the glass panel 20 and increase the ability of the glass panel of the present invention to accommodate a larger interstory drift 22 of the distorted curtain wall frame 24 before damage due to diagonal compressive forces as compared with the interstory drift 17 of a conventional square-corner glass panel 12.

In an embodiment of the present invention, rounded-corner glass panels are installed in lieu of square-corner glass panels in dry-glazed wall system glazing applications. Preferably, the rounded-corner of the glass panels have a polished finish, i.e., the finish appears smooth and mirror-like to the naked eye, and more preferably, the edges further have a polished finish as well. Any type of architectural glass panel can be employed in the present invention including monolithic, insulating, conventionally laminated, specially laminated (e.g., with advanced interlayers and/or various alternate material layers including polymeric materials such as polycarbonate) or applied film architectural glass panels. It is believed that glass panels of the present invention will find wide application in dry-glazed curtain wall and storefront wall systems. However, a wide variety of wall framing systems may be constructed with glass panels of the present invention to impart increased earthquake damage resistance to the architectural glass panels. Such wall systems use various methods of forming the weatherseal (e.g., rubber gaskets, sealants or a combination thereof) along the glazed panel perimeter, and in some configurations include provisions for anchoring the glass panel to the framing system. Regardless of the framing system or weatherseal materials used, it is preferred that neither the framing nor the weatherseal completely impede relative movement of a glass panel of the present invention with respect to its frame. For example, structural sealants are sufficiently flexible to allow movement of the glass panel, but hard glazing components (e.g., dried putty) designed to fix glass within a wall system frame would restrict movement, and wall systems using such glazing components would not fully benefit from glass panels of the present invention. Another feature of the various wall systems employing glass panels of the present invention is that they may employ various methods of attachment of the exterior wall system frame to the underlying main building frame.

Modified-geometry (e.g., rounded) corners may be added to annealed, heat-strengthened, fully tempered or chemically strengthened architectural glass vision or spandrel panels with no change in their method of fabrication, except that the addition of the modified-geometry (e.g., rounded) corners and the application of edge finishes should be made at the appropriate stage in their fabrication (e.g., before placement in the heat treatment furnace for heat-strengthened and fully tempered panels). The addition of modified-geometry (e.g., rounded) corners does not affect the use of solar coatings, thermal coatings, architectural coatings, etc. on glass panels. Glass panels fabricated in accordance with the present invention may be employed as monolithic architectural glass panels or may be used to produce value-added glazing components such as insulating glass units, conventional and specialty laminated glass units including glass-plastic laminates (laminates with multiple layers of glass and/or plastic), glass-clad-polycarbonate units, and filmed glass units.

Embodiments of the present invention include modified-geometry (e.g., rounded) corner glass panels of any feasible dimension coupled with edge finishing (e.g., flat polish, pencil polish, seamed edge, fine ground etc.), such as polished corners and preferably polished side edges. The glass panels can be of any type including annealed monolithic glass, heat-strengthened monolithic glass, fully tempered monolithic glass, chemically strengthened monolithic glass, etc. Such glass panels may comprise of any number and combination of the above types of glass individually or as glass units, such as insulating glass units, laminated glass units, or as glass composites including, glass-clad-polycarbonate, or glass-plastic laminated panes, and of any feasible dimension and with any appropriate polymeric interlayers/layers, and/or spacers and/or fill gas.

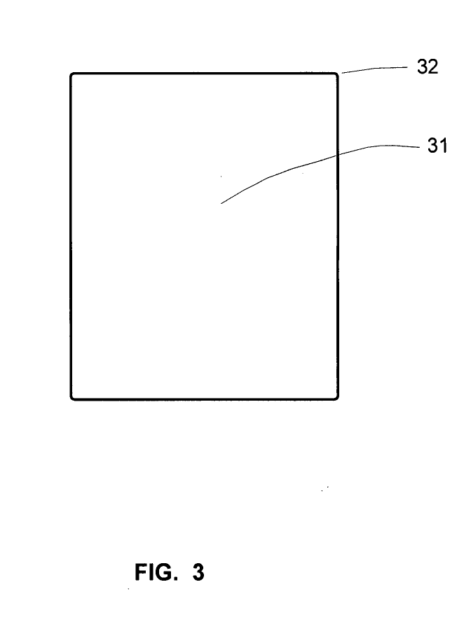

The various features and advantages of the present invention will become more apparent and facilitated by the following drawings. In one embodiment, rounded corner monolithic glass panels are used to replace square-corner monolithic glass panels. FIG. 3 is an elevation view of a monolithic glass panel 31 having four rounded corners 32, each of which has a radius R. The panel as drawn is not intended to limit the use of this invention to a particular glass panel aspect ratio, to particular panel dimensions, to a particular panel corner radius, or to a particular panel corner geometry.

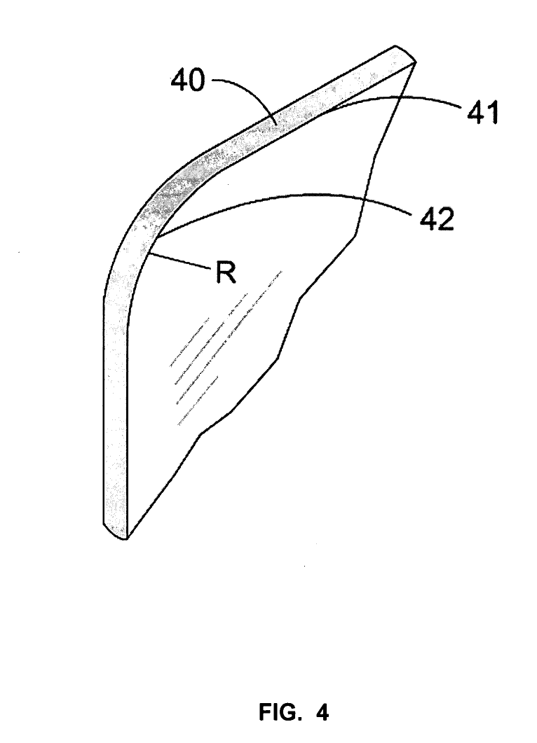

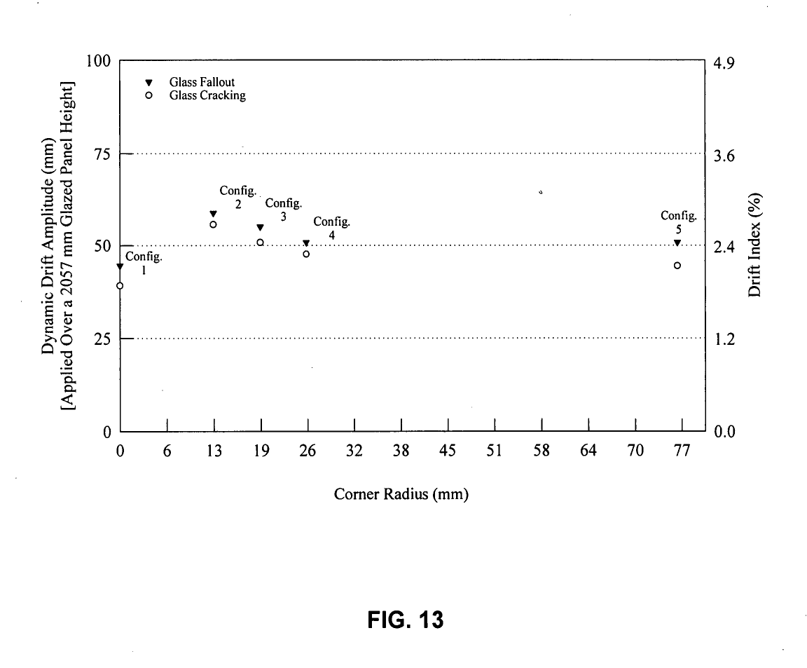

An isometric enlarged view of one corner section of the monolithic rounded corner glass panel in accordance with another embodiment of the present invention is depicted in FIG. 4. The panel thickness 40 drawn in FIG. 4 for this embodiment is not meant to restrict monolithic rounded corner glass panels to a particular thickness. However, such panels are typically of thickness normally used in architectural applications (e.g., as specified in ASTM C1036). The glass panel is drawn with a cut or raw edge 41 as is typically employed for annealed glass panels. In general, modified geometry (e.g., rounded) glass corners may be used in conjunction with the standard edge finish applied to panels of a given glass type (e.g., cut or scored edges in annealed glass; belt seamed edges for heat-strengthened and fully tempered glass; etc.). However, in a preferred embodiment of the invention, refined edge finishes may be used as subsequently described. The glass panel corner 42 in FIG. 4 with corner radius R, is meant to imply that the corner radius is not limited to a specific value. Evidence of this is found in FIG. 13, which is a presentation of the effect of corner radius on drift limit states observed for annealed monolithic glass panels with cut edges and ground corners of various radii dry-glazed with rubber gaskets, rubber side spacers and rubber setting blocks in a conventional extruded aluminum curtain wall frame and tested in accordance with the AAMA 501.6 recommended dynamic test method for determining the seismic drift causing glass fallout from a wall system. The choice of corner radii for rounded corner monolithic glass panels of any glass type will be based primarily on the requirement that no modifications to the glazing components for a particular wall system be required. For example, a desirable attribute would be maintenance of the weatherseal in the corner regions of the glazed frame so that air and moisture cannot pass through if the glass panel were shifted entirely to one side or the other of the glazing frame

Standard or conventional architectural glass cutting tolerances for fabricating the modified-geometry (e.g., rounded) corners may be used as was done for the specimens represented by the data in FIG. 13. However, as indicated by the test results presented in FIG. 13, results are enhanced by improving the quality of the edge finish. Hence, in a preferred embodiment of the invention, the edges of glass panels with rounded corners have smooth, well-finished surfaces to avoid the possible detrimental effects of edge surface defects.

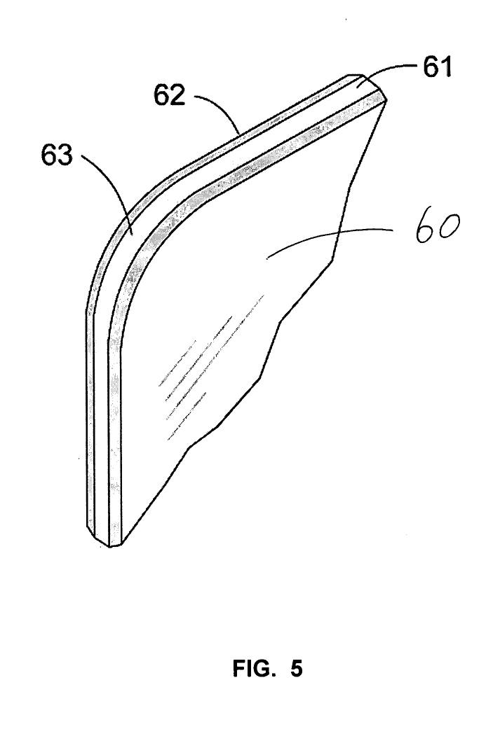

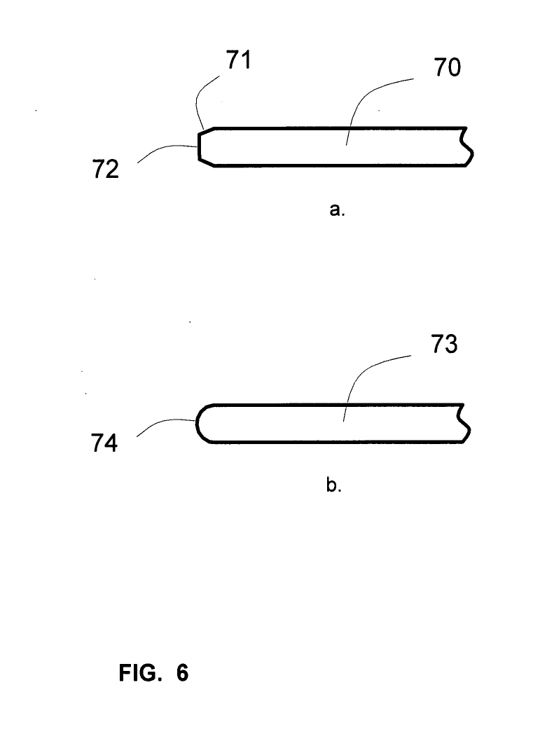

FIG. 5 illustrates another embodiment of a rounded corned glass panel. This figure shows an isometric view of one corner section of a monolithic rounded corner glass panel 60 with corner radius 63 R. This embodiment is an example of a rounded corner glass panel having a flat ground or polished edge 61. The thickness and corner radii dimensions drawn in FIG. 6 are not meant to limit the construction of a flat ground or polished rounded corner glass panel to these dimensions. Grinding and polishing operations may be achieved by additional fabricating steps as known to those skilled in the art of glass fabrication. The additional steps of grinding and polishing the edges of glass panels with modified geometry (e.g., rounded) corners may be practiced on practically any architectural glass panel constructed of any glass type, and, in addition to corner rounding, represents another embodiment of the invention whose improved level of glass edge surface refinement provides a more consistent (if not higher) level of seismic resistance to a given glass panel. FIGS. 6(a) and 6(b) show a rounded corner glass panel 70 and 73, respectively, fabricated in accordance with the invention, that include either a flat-72 or a pencil-shaped 74 edge. Either edge shape can be polished to a mirror finish.

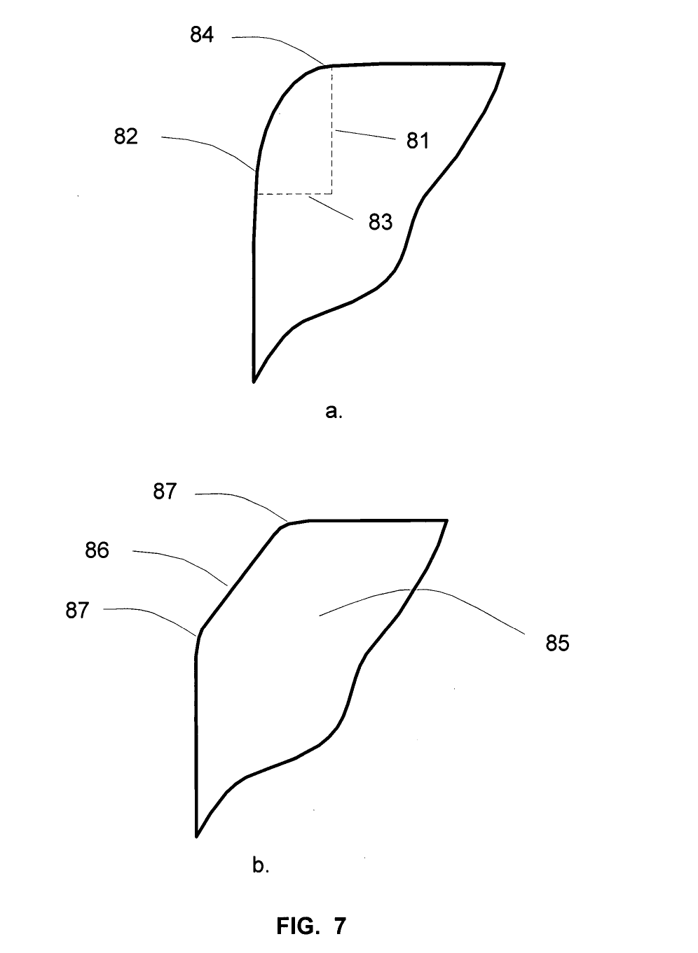

Another embodiment of the present invention applicable to architectural glass panels of any glass type is depicted in FIG. 7(a). In this schematic elevation view of one corner of a monolithic rounded corner glass panel, asymmetric rounding has been employed to provide one radius 81 along the vertical rounded corner edge 82 and another radius 83 along the horizontal rounded corner edge 84. Asymmetric rounding can be used to provide additional drift capacity to a rounded corner glass panel used in framing systems with small glass-to-frame clearances.

Another embodiment of an earthquake damage resistant glass panel of the present invention, is illustrated in FIG. 7b. The exemplary glass panel 85 is obtained by “clipping” material from each square corner of the panel shown thereby creating an angular corner 86 and providing a smooth contour at the intersections 87 of the panel edges and the clipped corner. Glass panels fabricated in this manner may have corners with a modified geometry that deviates from the well formed symmetric and asymmetric rounded radii previously discussed, yet still provide superior glass cracking and glass fallout resistance to comparable square-corner glass panels during earthquake racking motions. Moreover, these panels can be used in lieu of the rounded corner glass panels formed with symmetric or asymmetric radii in the glass unit constructions set forth in the embodiments below.

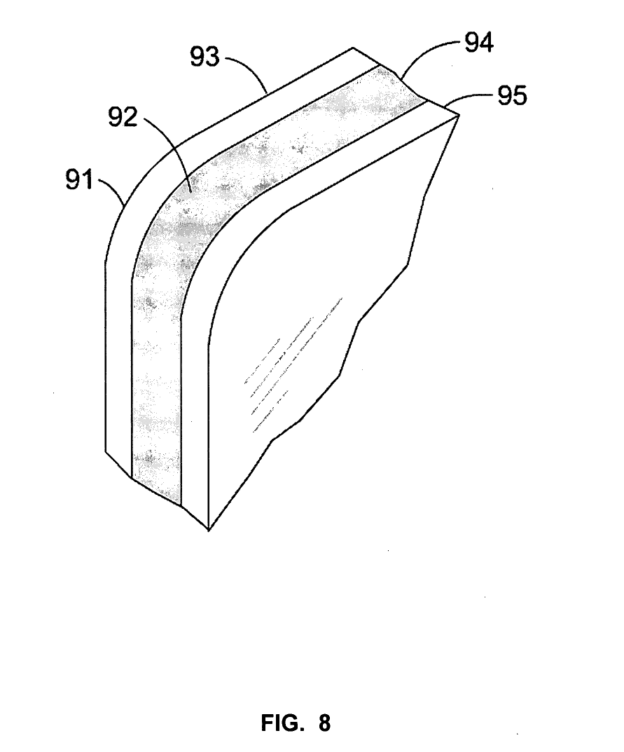

FIG. 8 depicts another embodiment of the present invention, wherein an isometric view of one corner of an insulating glass unit (IGU) is shown. The IGU is constructed with two rounded-corner radius 91 monolithic glass panes 93 and 95. A perimeter spacer 94 separates the two panes of glass. The spacer interior may be filled with air or an inert gas (e.g., argon), and the IGU may be sealed with primary 92 and secondary seals as is typical for IGU construction. IGUs constructed with any number and combination of monolithic, laminated or filmed glass panes can be formed from glass panes with modified-geometry (e.g., rounded) corners with the same dimensions or with any other dimensions suitable for constructing IGUs. Some considerations in the fabrication of insulating glass units constructed with modified-geometry (e.g., rounded) corner glass panes include glass pane alignment (minimal in-plane alignment offset of one pane with respect to the other), spacer design and the specific corner geometry and edge finish conditions of the individual panes. IGUs constructed with aligned glass panes offer maximum in-plane racking resistance. A variety of spacer technologies are available for IGUs, all of which may be used in IGUs constructed with modified-geometry (e.g., rounded) glass corners, but could require some adjustment to accommodate the IGU corner geometry selected for a particular application. For most currently used IGU spacer systems, up to a ½ in. (13 mm) corner radius on the glass panes may be employed without requiring the use of anything but a conventional IGU spacer. Generally, details regarding corner geometry (e.g., symmetric rounded, asymmetric rounded, and clipped) and glass edge surface finishes specified above for monolithic glass panels are applicable to the individual glass panes used in a given IGU construction of the present invention.

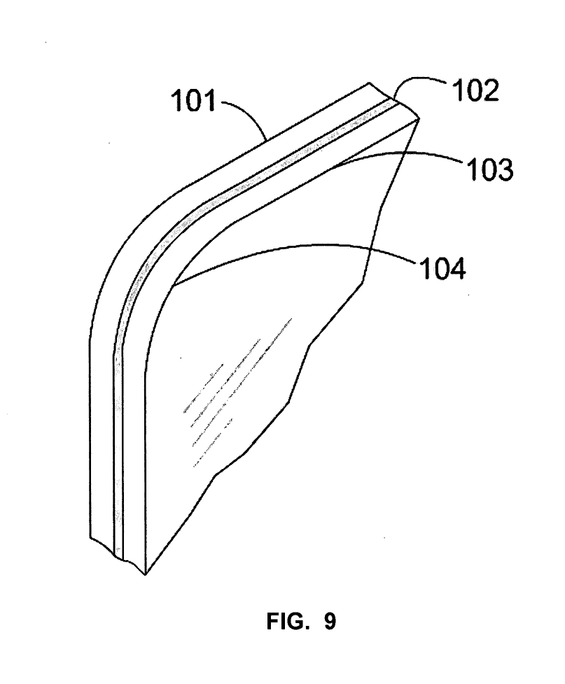

FIG. 9 is yet another embodiment of the present invention further illustrating the invention. Therein, a laminated glass unit is illustrated by an isometric view of one corner of a fabricated architectural laminated glass unit. The laminated glass unit is constructed with two, rounded-corner radius 104 monolithic glass panes 101 and 103 adhered to each other with a polymeric interlayer 102. The present invention contemplates the use of a variety of laminated glass units. These laminated glass units may be constructed with any number or combination of monolithic glass (of any glass type) and/or polymeric layers or panes and can be formed from glass panels of any type and dimensions with modified-geometry (e.g., rounded) corners. As with insulating glass units, alignment of glass plies is a consideration in the manufacture of laminated glass units employing the present invention. Selection of an appropriate corner geometry can be made in the same manner as that described for monolithic glass panels. Although polyvinyl butyral (PVB) is typically used as the interlayer material to bond glass plies in conventional two glass ply laminated glass unit construction, other interlayer/layer materials may also be used in laminated glass units constructed with modified-geometry (e.g., rounded) corner glass panels with no modifications required in their fabrication. It is preferred that the polymeric interlayer(s)/layer(s) material(s) be trimmed to the profile of the glass at the modified-geometry corner regions. Such laminated glass panels would include specialty laminated panels comprised of a glass ply and single or multiple polymeric layers adhered to the glass and/or each other for the purposes of imparting impact and abrasion resistance to the panel, among other desirable performance attributes. Generally, details regarding corner geometry (e.g., symmetric rounded, asymmetric rounded, and clipped) modifications, and glass edge surface finishes specified above for monolithic glass panels are applicable to the individual glass plies in a given laminated glass unit configuration of the present invention.

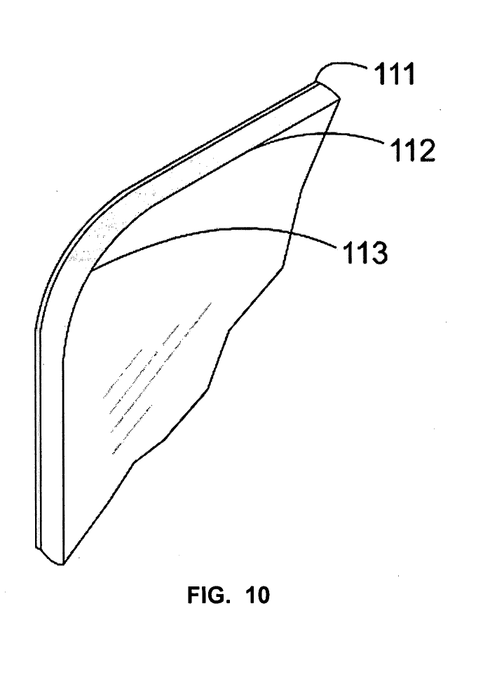

Monolithic glass panels having a polymeric film thereon can also be used in accordance with the present invention. An embodiment of which is shown in FIG. 10, which shows an isometric view of one corner of a fabricated rounded corner radius 113 monolithic glass panel 112 with an applied polymeric film 111. Architectural glass panels of any type, dimensions, modified-geometry corners and glass panel edges fabricated as described previously, or architectural applied film type, may be used without modification, although it is preferred that the polymeric film be trimmed to the profile of the glass at the modified-geometry corner regions. Selection of an appropriate corner geometry may be made in the same manner as that described for monolithic glass panels. Generally, details regarding corner geometry (e.g., symmetric rounded, asymmetric rounded, and clipped) modifications, and glass edge surface finishes specified above for monolithic, IGU and laminated glass panels also are applicable for the glass panels used in a given applied film glass unit construction.

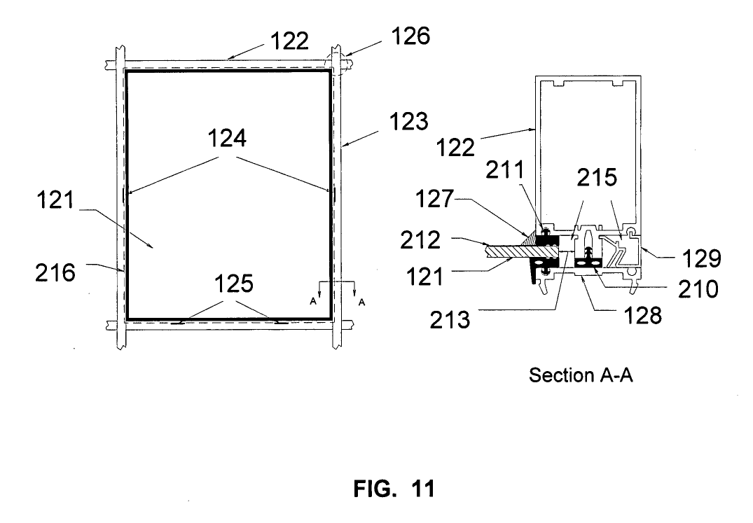

Additional glass fallout resistance can be imparted to applied film glass installations with modified-geometry (e.g., rounded) glass corners, as described previously, by anchorage of the film perimeter to the frame. One such embodiment of an anchored film rounded glass corner unit is shown in the elevation view and corresponding sectional view in FIG. 11. With reference to FIG. 11, the glass panel 121 with glass boundary 216 within the dry-glazed curtain wall frame section shown and bounded by extruded aluminum vertical mullions 123 and horizontal mullions 122, which are connected with shear blocks 126, rests upon rubber setting blocks 125 and maintains its side spacing 213 within the frame glazing pocket 215 with side blocks 124. The panel is secured within the frame with extruded aluminum pressure plates 128 and rubber gaskets 210 and 211. Additional glass panel attachment to the frame is provided by the structural silicone anchor bead 127 adhered to the film 212, which is applied to the filmed side of the glass panel and to the vertical and horizontal framing members along the entire glass panel perimeter. In framing those portions of a wall system that does not have glass panels on both sides of a given glazing pocket, an extruded aluminum perimeter filler 129 or special pressure plate extrusion is used. The use of anchored applied film is applicable to any of the aforementioned applied film glass panels of the present invention within a wide variety of wall framing systems.

For existing building wall systems constructed with glass panels containing annealed monolithic glass, it would be possible to retrofit those panels with modified-geometry (e.g., rounded) glass corners on site using commercially available, portable, glass cutting, sanding and grinding/polishing equipment. Alternatively, for existing wall systems containing glass panels of any type (annealed, heat-strengthened, fully tempered, chemically strengthened) or construction (e.g., monolithic, IGU, laminated) the original glass panels can be replaced with glass panels fabricated with modified-geometry (e.g., rounded) corners off site.

### EXAMPLES

The following examples are intended to further illustrate certain embodiments of the invention that have been evaluated experimentally and are not limiting in nature.

In-plane dynamic racking crescendo tests described below were performed on full-scale specimens of the architectural glass configurations in Table 1 and Table 2. Tests were performed on the Dynamic Racking Test Facility described in greater detail by Behr and Belarbi (1996) and in AAMA 501.6 (AAMA; 2001). Single-panel specimens were tested. Each specimen was centered between the sliding steel tubes of the test facility, and the vertical mullions of the curtain wall specimen were anchored at all four corners to the facility's sliding steel tubes. These steel tubes slide on roller assemblies in opposite directions by means of a fulcrum and pivot arm mechanism. The bottom sliding steel tube was displaced by a computer controlled electrohydraulic servoactuator having a dynamic stroke capacity of ±76 mm (±3 in.). The fulcrum and pivot arm mechanism attached to the top and bottom sliding steel tubes doubled the effective servoactuator stroke capacity to ±152 mm (+6 in.).

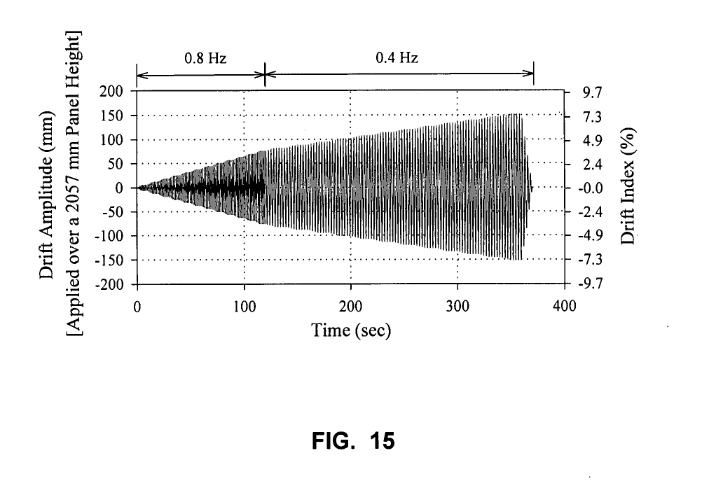

The crescendo test (FIG. 15) consisted of a series of alternating “ramp up” and “constant amplitude” intervals, each comprising four sinusoidal cycles at a nominal frequency of 0.8 Hz for drift amplitudes up to ±76 mm (±3 in.) and 0.4 Hz for drift amplitudes from ±76 mm up to the facility limit of ±152 mm (±6 in.). Detailed discussions related to the choice of this particular loading protocol and its appropriateness for seismic testing of architectural glass curtain wall can be found in Behr and Belarbi (1996), Pantelides et al. (1996), and Truman et al. (1996).

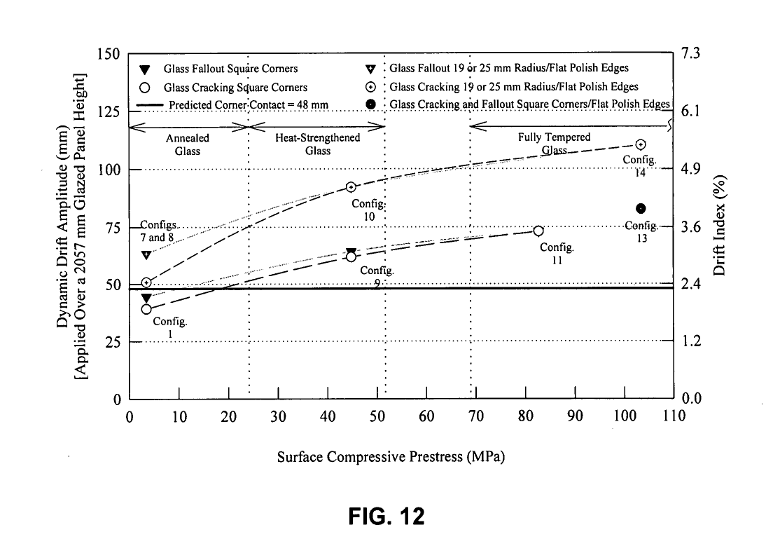

Two measures related to the seismic performance of architectural glass, serviceability drift capacity and ultimate drift capacity (defined above), were documented in this study. For test results to be applicable to buildings with various story heights, drift capacities are also expressed as drift indices on the right vertical axis in FIGS. 12, 13, 14, 15 and 20. Here the drift index associated with a particular drift capacity is determined by dividing that drift capacity (in mm) by the glazed panel height of 2057 mm and multiplying by 100 to express the results as a percentage.

Glass dimensions were chosen to allow comparisons with seismic drift capacities measured during previous studies conducted on similarly glazed square-corner specimens by Behr (1998). All glass panels in Table 1 and Table 2 were 1.52 m wide by 1.83 m high (¼ in. by 5 ft by 6 ft), and were installed in a dry-glazed, Kawneer 1600™ wall system (similar in many aspects to that in FIG. 11), which uses rubber gaskets between the glass and the aluminum curtain wall frame to secure each glass panel perimeter. A number of monolithic and insulating glass unit configurations were tested. Monolithic glass panels were 6 mm thick (¼ in.) and insulating glass units were about 25 mm (1 in.) thick and constructed with two 6 mm (¼ in.) thick monolithic glass panels separated by a 13 mm (½ in.) aluminum spacer. Rubber setting blocks were located at the quarter points to support the bottom horizontal glass edge, and rubber side spacers were located at mid-height of each vertical glass edge. Viewing windows were cut in the pressure plates at the corner regions of some of the specimens to facilitate observing glass-to-frame contacts during the tests.

The wall system type, glass panel dimensions, glazing system details, and other test configuration details were selected to allow comparisons with seismic drift limits measured during previous studies conducted on similarly glazed specimens. Selection of these parameters in the previous study was made after conducting a survey of industry professionals to identify selections that were deemed by the survey participants as being representative of contemporary mid-rise building design practice (Behr 1998) The effects of three variables on the seismic drift capacity performance of the monolithic glass panels subjected to simulated seismic movements were evaluated: (1) radius of curvature at each corner; (2) glass edge/corner finish; and (3) glass type. Only glass type was varied for the insulating glass units tested using a preferred embodiment of corner radius and glass edge/corner finish that was developed based on the results obtained for the monolithic glass specimens in Table 1.

Configurations 1-5 in Table 1 were annealed (AN) float glass, which has a residual surface stress less than 24 MPa (3,500 psi), and is the predominant flat glass type on the market. The glass edge finish for these specimens is designated as “cut” in reference to the standard condition of “scored and broken” AN glass panel edges. This edge finish results from the process of scoring the panel with a glass cutting wheel and breaking the panel along the scored line. The “ground” corner edge finish was obtained by contouring the radius of the glass edges at the rounded corners using standard belt sanding equipment after material at the corners was removed. Configurations 1-5 were included to determine the effect of various radii of curvature at each corner of the annealed (AN) monolithic glass panels (0 mm [square corner], 13 mm, 19 mm, 25 mm, and 76 mm).

TABLE 1
Test matrix and observed drift capacities for monolithic glass panels subjected to dynamic racking crescendo tests.^{a}

| | | | | | | | Average Glass |
|---|---|---|---|---|---|---|---|
| | Monolithic | Corner | | | Number of | Average Glass Cracking Drift, mm (in.) | Fallout Drift,^{c} mm (in.) |
| | Glass | Radius | Edge | Corner | Specimens | Standard Deviation, mm (in.) | Standard Deviation, mm (in.) |
| Config. | Type | mm (in.) | Finish | Finish | Tested | [Underlying Data Points,^{b} mm] | [Underlying Data Points, mm] |
| 1 | 6 mm AN | 0 (square) | Cut | Cut | 6 | 39.1 (1.54) 2.6 (0.10) | 44.5 (1.75) 0 (0) |
| | | | | | | [38.1, 38.1, 38.1, 38.1, 38.1, 44.5] | [44.5, 44.5, 44.5, 44.5, 44.5, 44.5] |
| 2 | 6 mm AN | 13 (½ in.) | Cut | Ground | 4 | 55.6 (2.19) 6.1 (0.24) | 58.7 (2.31) 9.7 (0.38) |
| | | | | | | [63.5, 50.8, 50.8, 57.2] | [69.9, 50.8, 50.8, 63.5] |
| 3 | 6 mm AN | 19 (¾ in.) | Cut | Ground | 3 | 50.8 (2.00) 6.4 (0.25) | 55.1 (2.17) 3.6 (0.14) |
| | | | | | | [57.2, 44.5, 50.8] | [57.2, 50.8, 57.2] |
| 4 | 6 mm AN | 25 (1 in.) | Cut | Ground | 2 | 47.8 (1.88) 4.6 (0.18) | 50.8 (2.00) 0 (0) |
| | | | | | | [50.8, 44.5] | [50.8, 50.8] |
| 5 | 6 mm AN | 76 (3 in.) | Cut | Ground | 1 | 44.5 (1.75) N/A | 50.8 (2.00) N/A |
| | | | | | | [44.5] | [50.8] |
| 6 | 6 mm AN | 25 (1 in.) | Seamed | Ground | 3 | 74.2 (2.92) 3.6 (0.14) | 78.2 (3.08) 7.4 (0.29) |
| | | | | | | [76.2, 69.9, 76.2] | [82.6, 69.9, 82.6] |
| 7 | 6 mm AN | 19 (¾ in.) | Flat | Flat | 1 | 44.5 (1.75) N/A | 63.5 (2.50) N/A |
| | | | Polish | Polish | | [44.5] | [63.5] |
| 8 | 6 mm AN | 25 (1 in.) | Flat | Flat | 1 | 50.8 (2.00) N/A | 63.5 (2.50) N/A |
| | | | Polish | Polish | | [50.8] | [63.5] |
| 9 | 6 mm HS | 0 (square) | Seamed | Seamed | 8^{d} | 62.0 (2.44) 8.1 (0.32) | 64.3 (2.53) 8.6 (0.34) |
| | | | | | | [76.2, 57.2, 57.2, 50.8, 63.5, 57.2, 69.9, | [82.6, 57.2, 57.2, 63.5, 63.5, 57.2, |
| | | | | | | 63.5] | 69.9, 63.5] |
| 10 | 6 mm HS | 19 (¾ in.) | Flat | Flat | 2 | 92.2 (3.63) 4.6 (0.18) | 92.2 (3.63) 4.6 (0.18) |
| | | | Polish | Polish | | [88.9, 95.3] | [88.9, 95.3] |
| 11 | 6 mm FT | 0 (square) | Seamed | Seamed | 7^{d} | 73.2 (2.88) 10.4 (0.41) | 73.2 (2.88) 10.4 (0.41) |
| | | | | | | 68.1 (2.68)^{e} 16.3 (0.64) | 68.1 (2.68)^{e} 16.3 (0.64) |
| | | | | | | [76.2, 57.2, 69.9, 88.9, 69.9, 76.2, 38.1^{e}] | [76.2, 57.2, 69.9, 88.9, 69.9, 76.2, |
| | | | | | | | 38.1^{e}] |
| 12 | 6 mm FT | 25 (1 in.) | Seamed | Rough | 4 | 46.0 (1.81) 3.3 (0.13) | 46.0 (1.81) 3.3 (0.13) |
| | | | | Ground | | [50.8, 44.5, 44.5, 44.5] | [50.8, 44.5, 44.5, 44.5] |
| 13 | 6 mm FT | 0 (square) | Flat | Flat | 3 | 82.6 (3.25) 0 (0) | 82.6 (3.25) 0 (0) |
| | | | Polish | Polish | | [82.6, 82.6, 82.6] | [82.6, 82.6, 82.6] |
| 14 | 6 mm FT | 25 (1 in.) | Flat | Flat | 6 | 110.0 (4.33) 9.7 (0.38) | 110.0 (4.33) 9.7 (0.38) |
| | | | Polish | Polish | | [108.0, 108.0, 120.7, 95.3, 120.7, 108.0] | [108.0, 108.0, 120.7, 95.3, 120.7, |
| | | | | | | | 108.0] |

^{a}All specimens were constructed with nominal 11 mm (0.43 in.) glass-to-frame clearances on all four sides.
^{b}Drift capacities for underlying data points are reported to the nearest 6.4 mm (0.25 in.) because the crescendo test was conducted in 6.4 mm (0.25 in.). increments to facilitate recording of the drift capacities.
^{c}The glass fallout reported is the fallout of a glass fragment with a surface area greater than 645 mm² (1 in²).
^{d}Tests on these specimens were performed in a previous study reported by Behr (1998).
^{e}Underlined average drift limits and their associated standard deviations were computed by including the underlined outlier listed in the underlying data points to demonstrate the vulnerability of FT Monolithic glass panels to dynamic racking motions when protrusions are present. The underlined drift capacities are not included in the other drift capacity averages and standard deviations reported

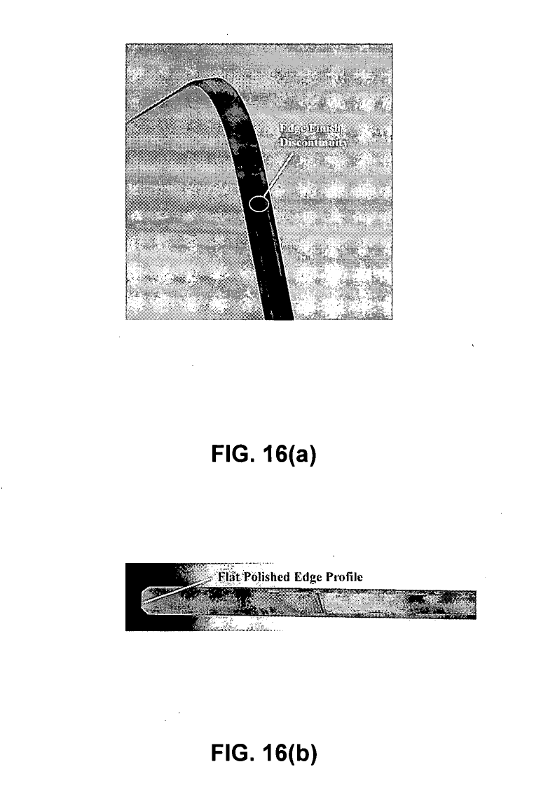

Configurations 6-14 in Table 1 and 1-3 in Table 2 were included to evaluate the effects of glass edge/corner finishes and glass type (AN, heat-strengthened [HS], and fully tempered [FT]) for RCG panels. For increased strength, AN glass is subjected to heat treatment, which results in increased levels of compressive residual stress at glass surfaces and glass edges. Conventionally, HS glass should have a residual surface compressive stress between 24 MPa and 52 MPa (3,500 psi and 7,500 psi), while FT glass should have a minimum residual surface compressive stress of 69 MPa (10,000 psi) (ASTM 2003). In this study, surface compressive prestress in each specimen was measured using a grazing angle surface polarimeter (GASP) in accordance with ASTM C 1048 (ASTM 2003). A “seamed” edge and corner finish is used for HS and FT glass types, and the finish is normally produced by belt sanding the sharp edges of the cut annealed glass panels prior to moving them to a furnace for heat-treatment. A “flat polish” edge and corner finish and most “ground” edge finishes are produced with specialized grinding and polishing equipment, and the finish is characterized by a very smooth and precisely formed surface (FIG. 16b and FIG. 19). Flat polishing is often used as a finishing technique for glass panels used in interior building partitions or for other decorative architectural glass components, but not normally for glass panels used in exterior wall systems. The “rough ground” corner finish of Configuration 12 (FIG. 16c) left glass protrusions along the rounded corners, rather than the smooth and continuous curvature that was typical of the other rounded corner configurations.

Test Results

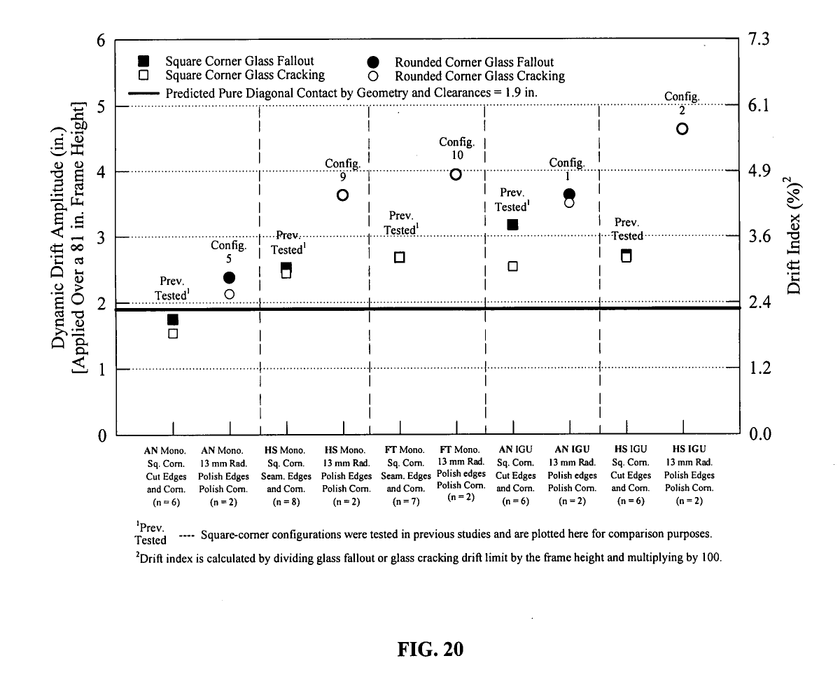

The seismic drift capacities for each configuration presented in Table 1 are plotted in FIGS. 12, 13, and 14 and the drift capacities for each configuration in Table 2 are plotted in FIG. 20. Summary statistics from comparisons to determine whether observed differences between various configurations are statistically significant are presented in Table 3 for the configurations in Table 1 and in Table 4 for the configurations in Table 2.

Performance of Annealed Monolithic Glass

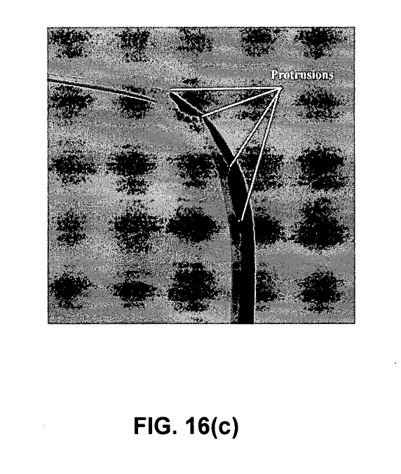

Average Δ_{cracking} and Δ_{fallout} drift capacities for Configurations 1-5 (AN monolithic glass panels) in Table 1 are plotted in FIG. 13 against the glass panel corner radii. These configurations had cut edges, except along the rounded portion of the corners for Configurations 2-5, which had ground edges as shown in FIG. 17. In studying the test results for Configurations 1-5, it is useful first to compare the overall average drift capacities for those specimens with rounded corners (Configurations 2 through 5) with the average drift capacities for Configuration 1 (square corners). Average Δ_{cracking} for the ten rounded corner specimens tested for Configurations 2 through 5 is 51.6 mm (2.03 in.), which is 32% larger than the average Δ_{cracking} for square corners. Average Δ_{fallout} for Configurations 2 through 5 is 55.4 mm (2.18 in.), which is 24% larger than the average glass fallout drift for square corners. These Δ_{cracking} and Δ_{fallout} differences are significant, as shown in Table 3, which suggests that significant increases in drift capacities can be realized by corner rounding, at least within the range of radii tested.

Of the radii tested, the 13 mm (½ in.) radius produced the highest average Δ_{cracking} and Δ_{fallout} drift capacities. However, drift capacities trended downward from the 13 mm radius through the 76 mm (3 in.) radius, which was the maximum corner radius tested in this study. The average increase in Δ_{cracking} for Configuration 2 (with 13 mm (½ in.) radius) over that for Configuration 1 (with square corners) is 42%, which is significant. The observed increase of 32% in Δ_{fallout} is also significant. However, the observed decreases in drift capacities for radii exceeding 13 mm were not significant. This finding suggests that beyond a certain amount of corner rounding, the radius has a less pronounced influence on drift capacities.

TABLE 2
Observed drift capacities for monolithic glass panels and insulating glass units
prepared with corner and edge finish treatment described in FIG. 19 and subjected to dynamic
racking crescendo tests in accordance with AAMA 501.6^{a}.

| | | | | | | | Square |
|---|---|---|---|---|---|---|---|
| | | | | | | | Edged |
| | | | | | | | Counterpart |
| | | | | | Average Glass | Average Glass | Average Glass |
| | | | | | Cracking Drift, | Fallout Drift, mm | Cracking and |
| | | Corner | | Number of | mm (in.) | (in.) | Average Glass |
| Configuration | | Radius | Edge/Corner | Specimens | [Underlying Data | [Underlying Data | Fallout Drift, |
| Number/Glass Type | | mm (in.) | Finish | Tested | Points, in.]^{b} | Points, in.]^{b,c} | in.^{d} |
| 1. | 1/4 in. CLR | 13 (½ in.) | Flat Polish & | 2 | 2.13 | 2.38 | 1.54 crack |
| | ANMonolithic | | Ground/Flat | | [2.0, 2.25] | [2.25, 2.5] | 1.75 fallout |
| | | | Polish | | | | |
| 2. | ¼ in. CLR HS | 13 (½ in.) | Flat Polish & | 2 | 3.63 | 3.63 | 2.44 crack |
| | Monolithic | | Ground/Flat | | [3.0^{e}, 4.25] | [3.0^{e}, 4.25] | 2.53 fallout |
| | | | Polish | | | | |
| 3. | ¼ in. CLR FT | 13 (½ in.) | Flat Polish & | 4 | 3.94 | 3.94 | 2.68 crack |
| | Monolithic | | Ground/Flat | | [3.5^{e}, 4.0, 3.25^{e}, | [35^{e}, 4.0, 3.25^{e}, | 2.68 fallout |
| | | | Polish | | 5.0] | 5.0] | |
| 4. | IGU with ¼ in. CLR | 13 (½ in.) | Flat Polish & | 2 | 3.5 | 3.63 | 2.54 crack |
| | AN lites and ½ in. | | Ground/Flat | | [3.5, 3.5] | [3.5, 3.75] | 3.17 fallout |
| | spacer. | | Polish | | | | |
| 5. | IGU with ¼ in. CLR | 13 (½ in.) | Flat Polish & | 2 | 4.63 | 4.63 | 2.67 crack |
| | HS lites and ½ in. | | Ground/Flat | | [4.74, 4.5] | [4.74, 4.5] | 2.71 fallout |
| | spacer. | | Polish | | | | |

^{a}All specimens were constructed with nominal 11 mm (0.43 in.) glass-to-frame clearances on all four sides.
^{b}Drift capacities for underlying data points are reported to the nearest 6.4 mm (0.25 in.) because the crescendo test was conducted in 6.4 mm (0.25 in.). increments to facilitate recording of the drift capacities.
^{c}The glass fallout reported is the fallout of a glass fragment with a surface area greater than 645 mm² (1 in²).
^{d}Tests on these specimens were performed in a previous study reported by Behr (1998).
^{e}Specimens highlighted with an asterisk also had some edges in their corner regions that had no polish and a rougher seam than other edges of specimens tested.

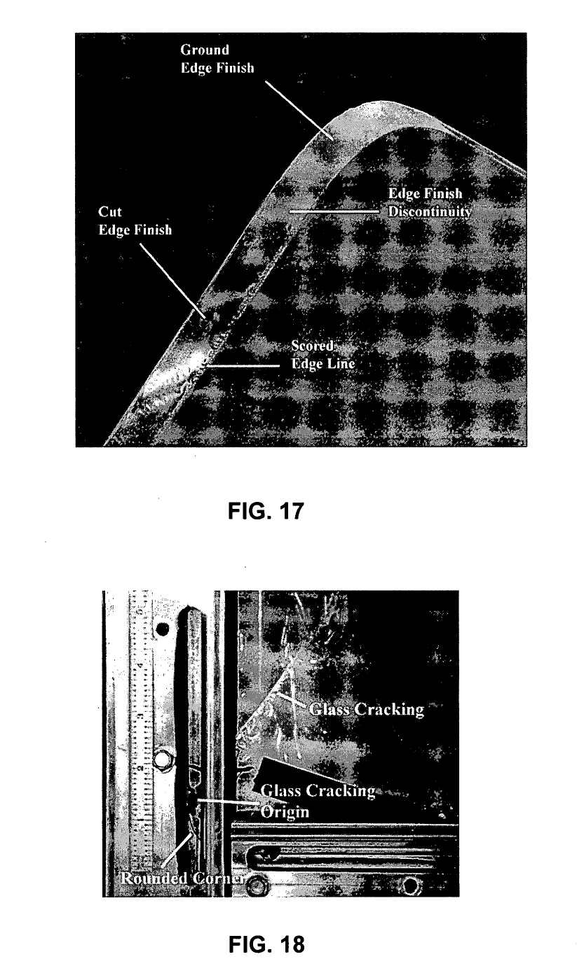

This trend of a reduction in drift capacities with increasing corner radius could be related to the difference in length of the ground edge at the corners. Visual observations during and after the tests revealed that the discontinuity that exists in the corner region at the point where the ground, rounded edge stops and the cut, straight edge begins is the point where glass cracking often originates in RCG panels. FIG. 18 shows an example of a glass panel crack that originated in the area of a corner discontinuity. One possible explanation for this trend is that with a larger radius, the RCG panel can rotate more freely than a panel with a smaller radius. Thus the corner glass edge discontinuity comes in contact with the framing element somewhat earlier than it does in RCG panels with a smaller radius, which leads to earlier glass failure. In a sense, it is fortuitous that the maximum drift capacity does not appear to occur in monolithic glass panels beyond a 13 mm (½ in.) corner radius. That is, specimens with a 13 mm corner radius would not, in most dry-glazed wall systems, require modification to the aluminum framing system in the corner regions to close the air gap that a larger radius rounded corner could produce.

TABLE 3
Summary of statistical comparisons for Table 1 configurations^{a}

| | Drift | | | | Observed |
|---|---|---|---|---|---|
| Configurations | capacity(s) | Observed | | | Difference |
| Compared | Compared^{b} | Difference | p-value^{c} | Parameter Investigated | Significant |
| 1 vs. 2 | cracking | 42% | 0.015 | corner radius | Yes |
| 1 vs. 2 | fallout | 32% | 0.005 | corner radius | Yes |
| 1 vs. 2-5 (avg.) | cracking | 34% | 0.000 | corner radius | Yes |
| 1 vs. 2-5 (avg.) | fallout | 25% | 0.001 | corner radius | Yes |
| 1 vs. 6 | cracking | 90% | 0.001 | edge finish | Yes |
| 1 vs. 6 | fallout | 76% | 0.015 | edge finish | Yes |
| 9 vs. 10 | cracking | 49% | 0.000 | edge finish | Yes |
| 9 vs. 10 | fallout | 43% | 0.000 | edge finish | Yes |
| 11 (w/ outlier) vs. 12 | cr. &fallout | −32% | 0.013 | edge finish | Yes |
| 11 (w/o outlier) vs. 13 | cr. &fallout | 13% | 0.076 | edge finish | No |
| 11 (w/o outlier) vs. 14 | cr. &fallout | 50% | 0.000 | edge finish | Yes |
| 13 vs. 14 | cr. &fallout | 33% | 0.001 | edge finish | Yes |
| 1 vs. 9 | cracking | 59% | 0.000 | glass type (AN vs HS) | Yes |
| 1 vs. 9 | fallout | 44% | 0.000 | glass type (AN vs HS) | Yes |
| 1 vs. 11 (w/o outlier) | cracking | 87% | 0.000 | glass type (AN vs FT) | Yes |
| 1 vs. 11 (w/ outlier) | fallout | 64% | 0.000 | glass type (AN vs FT) | Yes |
| 9 vs. 11 | cracking | 18% | 0.044 | glass type (HS vs FT) | Yes |
| 9 vs. 11 | fallout | 14% | 0.112 | glass type (HS vs FT) | No |
| 7/8 vs. 10 | cracking | 93% | 0.010 | glass type (polish AN vs polish HS) | Yes |
| 7/8 vs. 10 | fallout | 45% | 0.012 | glass type (polish AN vs polish HS) | Yes |
| 7/8 vs. 14 | cracking | 131% | 0.000 | glass type (polish AN vs polish FT) | Yes |
| 7/8 vs. 14 | fallout | 73% | 0.001 | glass type (polish AN vs polish FT) | Yes |
| 10 vs. 14 | cr. &fallout | 19% | 0.023 | glass type (polish HS vs polish FT) | Yes |
| ^{a}Glass cracking and glass fallout drift capacities were compared using two-sample t-tests at a confidence level of 95% assuming equal variances (Devore 1991). | | | | | |
| ^{b}Observed difference is calculated for configurations compared as [(2^{st} listed configuration drifit capacity − 1^{st} listed configuration drift capacity)/1^{st} listed configuration drift capacity] × 100. | | | | | |
| ^{c}A “p-value” was calculated in conjunction with the two-sample t-tests to determine the significance level achieved for the test. A significance level of 0.05 (i.e., 95% confidence level) was chosen as the acceptance criterion for statistical significance. A p-value* 0.05 indicates that the hypothesis that the means are equal should be rejected at the 95% confidence level (i.e., there are significant differences | | | | | |
| # in the limit state averages for the configurations being compared). A p-value > 0.05 indicates that the hypothesis of equal means should be accepted at the 95% confidence level. | | | | | |

TABLE 4
Summary of statistical comparisons for Table 2 configurations

| | Drift | | | | Observed |
|---|---|---|---|---|---|
| Configurations | capacity(s) | Observed | | | Difference |
| Compared | Compared | Difference | p-value | Parameter Investigated | Significant |
| 1 vs. square-corner | cracking | 28% | 0.001 | rounded vs square corner | Yes |
| counterpart | | | | | |
| 1 vs. square-corner | fallout | 26% | 0.000 | rounded vs square corner | Yes |
| counterpart | | | | | |
| 2 vs. square-corner | cracking | 33% | 0.008 | rounded vs square corner | Yes |
| counterpart | | | | | |
| 2 vs. square-corner | fallout | 30% | 0.015 | rounded vs square corner | Yes |
| counterpart | | | | | |
| 3 vs. square-corner | cr. &fallout | 32% | 0.017 | rounded vs square corner | Yes |
| counterpart | | | | | |
| 4 vs. square-corner | cracking | 27% | 0.031 | rounded vs square corner | Yes |
| counterpart | | | | | |
| 4 vs. square-corner | fallout | 13% | 0.263 | rounded vs square corner | No |
| counterpart | | | | | |
| 5 vs. square-corner | cr. &fallout | 42% | 0.001 | rounded vs square corner | Yes |
| counterpart | | | | | |
| 1 vs. 2 | cracking | 70% | 0.143 | glass type (FIG. 19 polish AN Mono. | No |
| | | | | vs FIG. 19. polish HS Mono.) | |
| 1 vs. 2 | fallout | 53% | 0.189 | glass type (FIG. 19 polish AN Mono. | No |
| | | | | vs FIG. 19. polish HS Mono.) | |
| 1 vs. 3 | cracking | 85% | 0.036 | glass type (FIG. 19 polish AN Mono. | Yes |
| | | | | vs FIG. 19. polish FT Mono.) | |
| 1 vs. 3 | fallout | 66% | 0.056 | glass type (FIG. 19 polish AN Mono. | No |
| | | | | vs FIG. 19. polish FT Mono.) | |
| 2 vs. 3 | cr. &fallout | 9% | 0.676 | glass type (FIG. 19 polish HS Mono. | No |
| | | | | vs FIG. 19. polish FT Mono.) | |
| 4 vs. 5 | cracking | 32% | 0.011 | glass type (FIG. 19 polish AN IGU | Yes |
| | | | | vs FIG. 19. polish HS IGU) | |
| 4 vs. 5 | fallout | 28% | 0.029 | glass type (FIG. 19 polish AN IGU | Yes |
| | | | | vs FIG. 19. polish HS IGU) | |
| ^{a}Glass cracking and glass fallout drift capacities were compared using two-sample t-tests at a confidence level of 95% assuming equal variances (Devore 1991). | | | | | |
| ^{b}Observed difference is calculated for configurations compared as [(2^{st} listed configuration drift capacity − 1^{st} listed configuration drift capacity)/1^{st} listed configuration drift capacity] × 100. | | | | | |
| ^{c}A “p-value” was calculated in conjunction with the two-sample t-tests to determine the significance level achieved for the test. A significance level of 0.05 (i.e., 95% confidence level) was chosen as the acceptance criterion for statistical significance. A p-value* 0.05 indicates that the hypothesis that the means are equal should be rejected at the 95% confidence level (i.e., there are significant differences | | | | | |
| # in the limit state averages for the configurations being compared). A p-value > 0.05 indicates that the hypothesis of equal means should be accepted at the 95% confidence level. | | | | | |

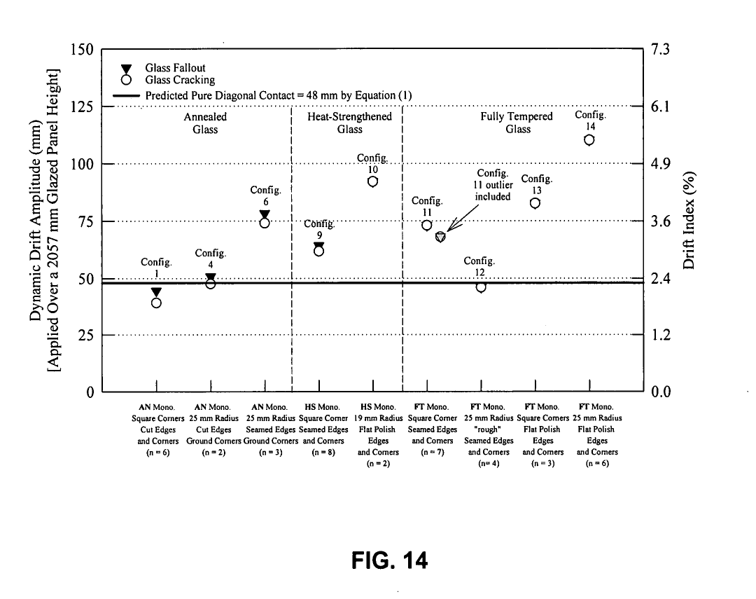

FIG. 14 indicates that larger drift capacities can be realized when an appropriate combination of rounded corners and glass edge finish is chosen. A comparison of the drift capacities for Configurations 1 and 4 (AN glass) in Table 1 indicates that the addition of a 25 mm (1 in.) rounded corner (Configuration 4) results in a modest 22% increase in Δ_{cracking} and a 14% increase in Δ_{fallout} over those for the square-corner Configuration 1. However, the combination of a 1 in. rounded corner with seamed edges (Configuration 6) results in significant increases (90% increase in Δ_{cracking} and a 76% increase in Δ_{fallout}) over those for Configuration 1. This finding suggests that AN RCG panels should be manufactured with at least a seamed edge finish. This performance for 25 mm (1 in.) rounded corner specimens with seamed edges (Configuration 6) is slightly better than the ±74 mm ( 2.9 in.) coincident Δ_{cracking} and Δ_{fallout} drift limits reported by Behr (1998) for FT monolithic rectangular glass panels (Configuration 11 in FIG. 14). Cut edges “catch” the frame more readily during glass-to-frame contacts than do seamed edges, which have a more smoothly rounded glass edge profile. This difference in glass-to-frame contact behavior is the primary reason for the significant Δ_{cracking} and Δ_{fallout} performance increases observed for AN RCG panels with seamed edges as compared to AN RCG panels with cut edges.

Performance of Heat Treated Glass

The combination of corner rounding and flat polished edges for HS and FT glass panels was also found to produce pronounced positive effects on drift capacities. For HS glass, the performance of a flat polished edge finish combined with a 19 mm (¾ in.) radius corner (Configuration 10) is contrasted in FIG. 14 with the performance of a seamed edge/square corner combination (Configuration 9) tested by Behr (1998). This comparison shows the advantage of combining a flat edge polish with corner rounding for HS glass. Statistical comparisons of drift capacities for Configuration 9 versus 10 in Table 3 indicated that both the observed Δ_{cracking} increase of 49% and the Δ_{fallout} increase of 43% are significant.

The high level of residual surface compressive stress existing in fully tempered glass causes it to fracture into small particles, which are often referred to as “dice.” Thus glass cracking and glass fallout drift capacities coincide for FT monolithic glass panels. Drift capacities for Configurations 11 through 14 in FIG. 14 depict the effects of rounding and edge/corner finishes on the performance of FT monolithic glass panels. Seven specimens were tested for Configuration 11, but one of these FT panels had a protrusion along its vertical edge in the lower right corner region of the specimen. As shown in Table 1, this protrusion reduced the drift capacity performance for that specimen to the extent that it was only on par with AN monolithic glass with square corners (Configuration 1). Moreover, the protrusion causes a 7% reduction in average drift capacities when it is included in the Configuration 11 (n=7) data set. This specimen's drift capacities represent outlying data that were previously dropped from consideration in the averages for the configuration (Behr 1998). However, such an edge condition could go unnoticed in the field and lead to the installation of a potentially defective glazing panel. Thus, for Configuration 11, two points are plotted in FIG. 14 to underscore the vulnerability of FT glass panels to early failure caused by protrusions along glass panel edges. The first of the plotted points corresponds to the average drift capacities for that configuration with outlying drift capacity data removed, while the second plotted point (with gray symbol fill) corresponds to the average drift capacities with the outlying drift limit data included in the averages.

Other shipments of FT glass received for testing from other glass manufacturers have also revealed that edge protrusions, and/or unseamed edges commonly exist on some of the panels within a given shipment of FT glass. In the case of a FT glass panel with an unseamed edge, limited test data [Δ_{cracking} and Δ_{fallout} of 31.8 mm (1.25 in.)] suggest that an unseamed edge also has a detrimental effect on drift capacity. Sensitivity of square-corner FT glass to protrusions led to the inclusion of Configuration 12 in the test plan to evaluate quantitatively the effect of edge protrusions on FT glass panels with rounded corners. Comparisons made in Table 3 between the drift capacities for Configurations 11 (with outlier included to present a worst-case comparison) and Configuration 12 indicated that the observed 32% decreases in both Δ_{cracking} and Δ_{fallout} drift capacities are statistically significant.

Adding a polished edge finish to a rectangular FT glass panel appears to reduce variability in drift capacities (Configuration 13 in Table 1), but the increase in drift capacity produced by the edge finish is insignificant (Configuration 11 vs. 13 in Table 3). In contrast, comparisons in Table 3 between Configurations 11 and 14 (flat-polished edges and 25 mm [1 in.] radius corners) indicate that the observed 50% increase in Δ_{cracking} and Δ_{fallout} is significant. Thus, as noted for rounding/seaming in AN glass panels, pronounced performance increases are also derived from the combination of a flat polished edge finish and rounded corners in FT glass panels. The drift index associated with glass cracking and glass fallout for Configuration 14 was 5.3%, which suggests that FT glass panels with rounded corners and flat polished edges could offer serviceable performance during building motions associated with severe earthquakes. The data for Configurations 11 through 14 also underscore the influence of quality control in the manufacture of FT rounded-corner glass panels on drift capacities.

Additional Observations

For a leftover specimen of the flat polished fully tempered Configuration 14, the effect of glass-to-frame clearance was investigated to a limited extent by reducing the 11 mm nominal clearance used in this study down to 3 mm (⅛ in.). This reduced clearance led to Δ_{cracking} and Δ_{fallout} drift capacities of 69.9 mm (2.75 in). Results from this test are not reported in Table 1 or included in FIG. 14. Despite the 36% decrease in drift capacities for a nearly 75% decrease in edge clearance when compared to Configuration 14, this drift capacity was comparable to square-corner FT glass panels glazed with a 11 mm nominal clearance (Configuration 11). The computed Δ_{cracking} and Δ_{fallout} drift index of 3.4% for this specimen suggests that even with reduced edge clearances, glass panels with rounded corners and flat polished edges could remain serviceable during interstory drifts that are more representative of severe earthquakes.

Another benefit observed for those configurations with polished edges and rounded corners is reduced frame damage when glass panel failure occurs. Glass panel failure often leaves behind significant scraping and gouging marks within the glazing pocket of aluminum frames such as those used in this study, but the glass panels with polished edges caused only minor cosmetic frame damage.

FIG. 12 depicts the effect of glass type on observed drift capacities. Spline interpolation through individual data points was used to construct the loci for conventional square-corner glass panels and rounded corner glass panels with flat-polished edges included in the figure. Drift capacities for Configurations 1, 9 and 11 in Table 1 are plotted along one locus in FIG. 12 to characterize the performance of 6 mm (¼ in.) square-corner monolithic panels as a function of measured surface compressive prestress. Drift capacities for Configurations 7, 8, 10 and 14 in Table 1 were used for the flat-polished glass locus plotted in FIG. 12. In addition, drift capacities for Configuration 13 (square-corner glass panels with flat-polished edges) were plotted as a separate point in the figure for reference.

The cracking drift capacities for the two AN panels with rounded corners and polished edges (Configuration 7 and 8 in Table 1) were no higher than those for AN panels with comparably rounded corners and cut edges (Configurations 3 and 4 in Table 1). This observation can be explained by noting that the corners of these specimens were not well polished during their manufacture. Thus glass cracking was initiated at the discontinuity (FIG. 16a) that existed at the point where the well-polished straight edge ended, and the less polished finish along the rounded corner began. Specimens of Configuration 10 and 14, HS and FT monolithic panels with polished edges, also had the same imperfect, polished finish quality in their corners as described for the Configuration 7 and 8 AN monolithic panels. Once again, glass cracking was observed to emanate from these edge discontinuities. Despite these similarities, no apparent detrimental effects on the drift capacity of the HS and FT panels was observed. Apparently, the higher edge compression in the HS and FT glass panels negates some of the effects of the discontinuity, which are problematic in AN RCG panels with flat-polished edges.

Despite the slightly lower than expected Δ_{cracking} for the AN polished panels, the trends of the two loci in FIG. 12 are comparable. For conventional square-corner glass panels, comparisons between Configurations 1, 9 and 11 suggest that: (1) HS glass has a 59% higher Δ_{cracking} than AN glass; (2) FT glass has a 87% higher Δ_{cracking} than AN glass; and (3) FT glass has a 18% higher Δ_{cracking} than HS glass. For monolithic RCG panels with flat polished edges, comparisons between drift capacity data for Configuration 7/8, 10 and 14, suggest that: (1) HS glass has a 93% higher Δ_{cracking} than AN glass; (2) FT glass has a 130% higher Δ_{cracking} than AN glass; and (3) FT glass has a 19% higher Δ_{cracking} than HS glass. In particular, the comparisons show close correlation between the relative Δ_{cracking} of HS glass with respect to FT glass, independent of the edge finish or corner geometry. Comparison of the lower curves with the upper curves also clearly shows the gain in drift capacities for RCG panels and the significant advantage of these panels in reducing the potential for earthquake-related glass damage.

The aforementioned data and observations from testing the glass specimens in Table 1 led to the development of the invention embodiment described in FIG. 19 and employed for the fabrication of the specimen configurations in Table 2. The same trends noted above for drift capacities as a function of glass type held for both the monolithic glass configurations and the insulating glass configurations in Table 2. Quantitative differences and statistical tests to establish whether these differences are significant for comparisons between each configuration in Table 2 and its square-corner counterpart, and for comparisons amongst the configurations, are presented in Table 4. From Table 4, it is clear that the corner radius and edge/corner finish embodiment employed for all the configurations in Table 2 yields superior glass cracking and glass fallout drift capacity performance over the conventional, square-corner glass panel counterparts to these configurations. The average glass cracking increase was 32% for Configurations 1-5 as compared to their square-cornered counterparts, and the average glass fallout was 29% for Configurations 1-5 as compared to their square-cornered counterparts. Thus, these data suggest that the embodiment yields a nearly uniform increase of at lest about 30% in both glass cracking and glass fallout across glass type (AN, HS, FT) and panel type (monolithic, insulating glass unit). If not for the increased variation in drift capacities for Configurations 2 and 3, which resulted from specimens that had slight problems with their finish quality, but were tested anyway, observed differences between drift capacities of Configurations 2, 3 and 4 would have all been statistically significant.

Glass panels of the present invention offer an economical seismic damage mitigation approach for architectural glass in both new buildings and existing buildings in earthquake-prone regions and elsewhere.

In accordance with the invention, the present invention is applicable to any architectural glass window system, including, but not limited to curtain wall systems, storefront wall systems, punched opening window systems, ribbon window systems, and strip window systems.

Conventional framing for glass units has substantially square or angular corner glazing pockets for receiving the square or angular corners of conventional rectangular or angular glass panels. In accordance with our invention, glass panels of the invention are mounted in conventional architectural glass framing, which reduces the friction between the glass corners and the framing glazing pocket during glass-to-frame contacts. The glass panels of the invention have a slightly reduced diagonal length, which allows them to rotate and translate more freely within the frame when the frame is subjected to dynamic, horizontal racking movements as would be expected during an earthquake. The reduced friction during glass-to-frame contacts and the increased mobility of the glass panel within its glazing pocket allows the glass panel to accommodate frame deformations more readily than its square-corner counterpart, which results in increased earthquake damage resistance as quantified by the serviceability (glass cracking) and ultimate (glass fallout) drift limits.

In the preceding detailed descriptions, the present invention is described with reference to specific exemplary embodiments thereof. It will, however, be evident that various modifications and changes may be made thereto without departing from the broader spirit and scope of the present invention, as set forth in the claims. The specifications and drawings are, accordingly, to be regarded as illustrative and not restrictive. It is understood that the present invention is capable of using various other combinations and environments and is capable of changes or modifications within the scope of the inventive concept as expressed herein.

### REFERENCES

American Architectural Manufacturers Association (AAMA), 2001. Recommended Dynamic Test Method for Determining the Seismic Drift Causing Glass Fallout from a Wall System, AAMA 501.6-01.
American Society of Civil Engineers (ASCE), 2003. Minimum Design Loads for Buildings and Other Structures, ASCE 7-02, Reston, Va.
ASTM International, 2003. Standard Specification for Heat-Treated Flat Glass—Kind HS, Kind FT, Coated and Uncoated Glass, C 1048-04, American Society for Testing and Materials, West Conshohocken, Pa.
Behr, R. A., 1998. Seismic performance of architectural glass in mid-rise curtain wall, J. Archit. Eng 4 (3), 94-98.
Behr, R. A., and Belarbi, A., 1996. Seismic test methods for architectural glazing systems, Earthquake Spectra 12 (1), 129-143.
Behr, R. A., Belarbi, A., and Brown, A. T., 1995a. Seismic performance of architectural glass in a storefront wall system, Earthquake Spectra 11 (3), 367-391.
Behr, R. A., Belarbi, A., and Culp, J. H., 1995b. Dynamic racking tests of curtain wall glass elements with in-plane and out-of-plane motions, Earthquake Eng. Struct. Dyn. 24 (1), 1-14.
Bouwkamp, J. G., 1960. Behavior of window panels under in-plane forces, Structures Material Research Series 100, Issues 7 and 8, University of California, Berkeley, Calif.
Brueggeman, J. L., Behr, R. A., Wulfert, H., Memari, A. M., and Kremer, P. A., 2000. Dynamic racking performance of an earthquake-isolated curtain wall system, Earthquake Spectra 16 (4), 735-756.
Brueggeman, J. L., Behr, R. A., Wulfert, H., Memari, A. M. and Kremer, P., “Dynamic Racking Performance of an Earthquake-Isolated Curtain Wall System,” EERI Earthquake Spectra Journal, Vol. 16, No. 4, pp. 735-756, November 2000.
Building Seismic Safety Council (BSSC), 2001. 2000 NEHRP Recommended Provisions for Seismic Regulations for New Buildings and Other Structures, Part 1-Provisions, prepared for the Federal Emergency Management Agency and issued as FEMA-368, Washington, D.C.
Devore, J. L., 1991. Probability and Statistics for Engineering and the Sciences, Brooks/Cole, Pacific Grove, Calif.
Earthquake Engineering Research Institute (EERI), 1990. Loma Prieta Earthquake Reconnaissance Report, Earthquake Spectra Supplement to Volume 6, Oakland, Calif.
EERI, 1995a. Northridge Earthquake Reconnaissance Report, Vol. 1, Earthquake Spectra Supplement to Volume 11, Oakland, Calif.
EERI, 1995b: The Hyogo-ken Nanbu Earthquake Jan. 17, 1995: Preliminary Reconnaissance Report, Oakland, Calif.
EERI, 2001: The Nisqually, Washington Earthquake Feb. 28, 2001: Preliminary Reconnaissance Report, Oakland, Calif.
Evans, D., Kennett, E., Holmes, W. T., and Ramirez, F. J. L., 1988. Glass Damage in the Sep. 19, 1985 Mexico City Earthquake, report prepared for NSF, CES-861093.
Flat Glass Manufacturers Association of Japan (FGMAJ), 1995. Glass Damage Report—A Report (Explanation) on Damage to Window Glass in the Great Hanshin Earthquake.
International Code Council (ICC), 2003. International Building Code 2003, Falls Church, Va.
Lim, K. Y. S., and King, A. B., 1991. The behavior of external glazing systems under seismic in-plane racking, Proceedings, Pacific Conference of Earthquake Engineering, Auckland, New Zealand.
Lingnell, A. W, 1994. Initial Survey and Audit of Glass and Glazing System Performance during the Earthquake in the Los Angeles Area on Jan. 17, 1994, final report submitted to Primary Glass Manufacturers Council, Lingnell Consulting Services.
Memari, A. M., Behr, R. A. and Kremer, P. A., “Seismic Behavior of Curtain Walls Containing Insulating Glass Units,” ASCE Journal of Architectural Engineering, Vol. 9, No. 2, pp. 70-85, June 2003. Memari et al. 2003
Memari, A. M., Chen, X., Kremer, P. A., and Behr, R. A., “Development of Failure Prediction Models for Structural Sealant Glazing Systems under Cyclic Racking Displacement Conditions,” Proceedings of 2006 Architectural Engineering Conference—Building Integration Solutions, Omaha, Nebr., March 30-Apr. 2, 2006, CD-ROM, 15 pages. Memari et al. 2006c
Memari, A. M., Kremer, P. A. and Behr, R. A., “Dynamic Racking Crescendo Tests on Architectural Glass Fitted with Anchored “PET” Film,” ASCE Journal of Architectural Engineering, Vol. 10. No. 1, pp. 5-14, March 2004. Memari et al. 2004
Memari, A. M., Shirazi, A. and Kremer, P. A., “Static Finite Element Analysis of Architectural Glass Curtain Walls Under In-Plane Loads and Corresponding Full-Scale Test,” Structural Engineering and Mechanics Journal, Vol. 25, No. 4, pp. 365-382, March 2007. Memari et al. 2007
Memari, A., Behr, R. A., and Kremer, P. A., 2004. Dynamic racking crescendo tests on architectural glass fitted with anchored “PET” film, J Archit. Eng. 10 (1), 5-14.
Memari, A. M., Chen, X., Kremer, P. A., and Behr, R. A., “Seismic Performance of Two-Side Structural Silicone Glazing Systems,” Journal of ASTM International (JIA), Vol. 3 No. 10, pp. 1-10, October 2006. Memari et al. 2006a
Memari, A. M., Kremer, P. A., and Behr, R. A., “Architectural Glass Panels with Rounded Corners to Mitigate Earthquake Damage,” Earthquake Spectra Journal, Volume 22, No. 1, pp. 129-150, February 2006. Memari et al. 2006b
National Fire Protection Association (NFPA), 2002. Building Construction and Safety Code, NFPA 5000, Quincy, Mass.
Pantelides, C. P, and Behr, R. A., 1994. Dynamic in-plane racking tests of curtain wall glass elements, Earthquake Eng. Struct. Dyn. 23, 211-228.
Pantelides, C. P., Truman, K. Z., Behr, R. A., and Belarbi, A., 1996. Development of a loading history for testing of architectural glass in a shop-front wall system, Eng. Struct. 18 (12), 917-935.
Sucuoglu, H., and Vallabhan, C. V G., 1997. Behavior of window glass panels during earth-quakes, Eng Struct. 19 (8), 685-694.
Thurston, S. J., and King, A. B., 1992. Two-directional Cyclic Racking of Corner Curtain Wall Glazing, Building Research Association of New Zealand (BRANZ) Study Report No. 44.
Truman, K. Z., Pantelides, C. P., Behr, R. A., and Belarbi, A., 1996. Comparison of linear and nonlinear seismic drift histories for midrise steel frames, Eng. Struct. 18 (8), 577-588.
Zarghamee, M. S., Schwartz, T. A., and Gladstone, M., 1996. Seismic behavior of structural silicone glazing, Science and Technology of Building Seals, Sealants, Glazing and Waterproofing, Vol. 6, ASTM STP 1286, edited by James C. Meyers, American Society for Testing and Materials, Philadelphia, Pa., pp. 46-59.

What is claimed is:

1. A building comprising at least one rectangular frame having an architectural glass panel with material removed at panel corners and fabricated with smooth edge contours in the corner regions, wherein the panel corners have a mirror polish which extends continuously down a portion of each edge of the glass.

2. The building of claim 1 wherein the mirror polish extends down at least six inches beyond the tangent points at each corner of the glass.

3. The building of claim 1 wherein the architectural glass panel has improved serviceability and ultimate drift capacity over the same glass having a square corner geometry of at least about 20%.

4. The building of claim 2 wherein the architectural glass panel has improved serviceability and ultimate drift capacity over the same glass having a square corner geometry of at least about 30%.

5. The building of claim 2 wherein the glass panel has a flat or pencil polish and wherein the glass panel has seamed or finely ground edges along all other portions of the glass panel edges.

6. The building of claim 1 wherein the glass panel has a flat or pencil polish along all edges of the glass panel.

7. The building of claim 1 wherein the corners of the glass panel are rounded.

8. The building of claim 1 wherein the corners of the glass panel have asymmetric radii or compound radii.

9. The building of claim 7, wherein the rounded corner glass panel has corner radii of about ¼ in. (6 mm) to about 2 in. (51 mm).

10. The building of claim 1 wherein the glass panel comprises annealed monolithic architectural glass, heat-strengthened monolithic architectural glass, fully tempered monolithic architectural glass, or chemically strengthened monolithic architectural glass.

11. The building of claim 1 comprising a curtain wall wherein at least one rectangular window frame is an element of the curtain wall.

12. The building of claim 1 comprising a storefront wall system wherein at least one rectangular window frame is an element of the storefront wall system.

13. The building of claim 1 comprising a punched opening window system, wherein at least one rectangular window frame is an element of the punch opening window.

14. The building of claim 1 comprising a ribbon window system, wherein at least one rectangular window frame is an element of the ribbon window.

15. The building of claim 1 comprising a strip window system, wherein at least one rectangular window frame is an element of the strip window.

16. A method of increasing the earthquake damage resistance of a glass panel in an existing building, the method comprising retrofitting or replacing an original glass panel in the building with a glass panel from claim 1.
